(19) United States
(12) Patent Application Publication
(10) Pub. No.: US 2009/0122282 A1
(43) Pub. Date: May 14, 2009

(54) Exposure apparatus, liquid immersion system, exposing method, and device fabricating method

(75) Inventor: Yasufumi Nishii, Kumagaya-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/153,430

(22) Filed: May 19, 2008

Related U.S. Application Data
(60) Provisional application No. 60/924,715, filed on May 29, 2007.
(60) Provisional application No. 60/996,568, filed on Nov. 26, 2007.

(30) Foreign Application Priority Data
May 21, 2007 (JP) 2007-134061
Nov. 14, 2007 (JP) 2007-295702

(51) Int. Cl. G03B 27/52; G03B 27/42; G03B 27/32

(52) U.S. Cl. 355/30; 355/53; 355/77

(57) ABSTRACT

An exposure apparatus exposes a substrate with exposure light through a liquid. The exposure apparatus comprises: a first surface, which is disposed around an optical path of the exposure light; a second surface, which is disposed adjacent to an outer edge of the first surface, that includes a first area, which is inclined with respect to the first surface; and a liquid recovery surface, which is disposed at an outer side of the second surface with respect to the optical path of the exposure light; wherein, when an object is disposed at a position at which it opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object.

### CROSS-REFERENCE TO RELATED APPLICATION

This application is a non-provisional application claiming priority to and the benefit of U.S. provisional application No. 60/924,715, filed May 29, 2007, and U.S. provisional application No. 60/996,568, filed Nov. 26, 2007. Furthermore, this application claims priority to Japanese Patent Application No. 2007-134061, filed May 21, 2007, and Japanese Patent Application No. 2007-295702, filed Nov. 14, 2007. The entire contents of which are incorporated herein by reference.

### BACKGROUND

1. Field of the Invention

The present invention relates to an exposure apparatus, a liquid immersion system, an exposing method, and a device fabricating method.

2. Description of Related Art

As disclosed in PCT International Publication WO99/049504, and PCT International Publication WO2006/106907 (corresponding to European Patent Application Publication No. 1873815), among exposure apparatuses used in photolithography, an immersion exposure apparatus is known that exposes a substrate with exposure light through a liquid.

With an immersion exposure apparatus, if a substrate is moved at high speed, then there is a possibility that it will become difficult to fill an optical path space of the exposure light between the substrate and an optical member of, for example, a projection optical system with a liquid in a desired state. In addition, if the substrate is moved at high speed, then there is a possibility that the liquid will leak from a prescribed space or remain on the substrate (as a film, a drop, or the like). Therefore, there is a possibility that exposure failures will occur such as the generation of defects in the pattern that is formed on the substrate. As a result, there is a possibility that defective devices will be fabricated.

A purpose of some aspects of the invention is to provide: an exposure apparatus that can prevent a liquid from remaining on an object, e.g., a substrate, and thereby prevent exposure failures from occurring; and an exposing method. Another purpose is to provide a liquid immersion system that can prevent the liquid from remaining on the object, e.g., the substrate. Yet another purpose is to provide a device fabricating method that can prevent defective devices from being produced.

### SUMMARY

A first aspect of the invention provides an exposure apparatus that exposes a substrate with exposure light through a liquid, and comprises: a first surface, which is disposed around an optical path of the exposure light; a second surface, which is disposed adjacent to an outer edge of the first surface, that includes a first area, which is inclined with respect to the first surface; and a liquid recovery surface, which is disposed at an outer side of the second surface with respect to the optical path of the exposure light; wherein, when an object is disposed at a position at which it opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object.

A second aspect of the invention provides a device fabricating method that comprises the steps of: exposing a substrate using an exposure apparatus according the first aspect of the invention; and developing the exposed substrate.

A third aspect of the invention provides a liquid immersion system that is used by an immersion exposure, which exposes a substrate with exposure light through an optical member and a liquid, in order to fill an optical path between the optical member and the substrate with the liquid, and comprises: a first surface; a second surface, which is disposed adjacent to an outer edge of the first surface, that includes a first area, which is inclined with respect to the first surface; and a liquid recovery surface, which is disposed at an outer side of the second surface with respect to the first surface; wherein, when an object is disposed at a position at which it opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object.

A fourth aspect of the invention provides an exposing method that comprises the steps of: using a liquid immersion system according to the third aspect of the invention to fill a space between a substrate and an optical member of the immersion exposure apparatus with a liquid; and radiating an exposure light to the substrate through the optical member and the liquid.

A fifth aspect of the invention provides a device fabricating method that comprises the steps of: exposing a substrate using an exposing method according to the fourth aspect of the invention; and developing the exposed substrate.

A sixth aspect of the invention provides an exposure apparatus that exposes a substrate with exposure light through a liquid, and comprises: a first surface, which is disposed around an optical path of the exposure light; a second surface, which is disposed adjacent to an outer edge of the first surface; and a liquid recovery surface, which is disposed at an outer side of the second surface with respect to the optical path of the exposure light; wherein, when an object is stationary at a position at which it opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object; in addition, an interface of the liquid on the object is formed in the vicinity of a boundary between the second surface and the liquid recovery surface.

A seventh aspect of the invention provides a device fabricating method that comprises the steps of: exposing a substrate using an exposure apparatus according to the sixth aspect of the invention; and developing the exposed substrate.

An eighth aspect of the invention provides an exposure apparatus that exposes a substrate with exposure light through a liquid, and comprises: a first surface, which is disposed around an optical path of the exposure light; a second surface, which is disposed adjacent to an outer edge of the first surface; and a liquid recovery surface, which is disposed at an outer side of the second surface with respect to the optical path of the exposure light; wherein, the liquid recovery surface comprises a third area, which is disposed at the outer side of the second surface with respect to the optical path of the exposure light, and a fourth area, which is disposed at the outer side of the third area with respect to the optical path of the exposure light; when an object is disposed at a position at which it opposes at least part of the first surface and at least part of the liquid recovery surface, a spacing between the second surface and the object is larger than a spacing between the first surface and the object, a spacing between the third area and the object is larger than the spacing between the first surface and the object, and the spacing between the fourth area and the object is smaller than the spacing between the third area and the object in a prescribed direction that is substantially perpendicular to a front surface of the object; and a size of the fourth area is larger than a size of the third area in a radial direction with respect to the optical path of the exposure light.

A ninth aspect of the invention provides an exposure apparatus that exposes a substrate with exposure light through a liquid, and comprises: a first surface, which is disposed around an optical path of the exposure light; a second surface, which is disposed adjacent to an outer edge of the first surface; and a liquid recovery surface, which is disposed at an outer side of the second surface with respect to the optical path of the exposure light, that recovers the liquid by suctioning it; wherein, the liquid recovery surface comprises a third area, which is disposed at the outer side of the second surface with respect to the optical path of the exposure light, and a fourth area, which is disposed at the outer side of the third area with respect to the optical path of the exposure light; when an object is disposed at a position at which it opposes at least part of the first surface and at least part of the liquid recovery surface, a spacing between the second surface and the object is larger than a spacing between the first surface and the object, a spacing between the third area and the object is larger than the spacing between the first surface and the object, and the spacing between the fourth area and the object is smaller than the spacing between the third area and the object in a prescribed direction that is substantially perpendicular to a front surface of the object; and a suction force at the fourth area is different than a suction force at the third area.

A tenth aspect of the invention provides a device fabricating method that comprises the steps of: exposing a substrate using an exposure apparatus according to the eighth and ninth aspects of the invention; and developing the exposed substrate.

An eleventh aspect of the invention provides a liquid immersion system that is used by an immersion exposure, which exposes a substrate with exposure light through an optical member and a liquid, in order to fill an optical path between the optical member and the substrate with the liquid, and comprises: a first surface; a second surface, which is disposed adjacent to an outer edge of the first surface; and a liquid recovery surface, which is disposed at an outer side of the second surface with respect to the first surface; wherein, when an object is stationary at a position at which it opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object; in addition, an interface of the liquid on the object is formed in the vicinity of a boundary between the liquid recovery surface and the second surface.

A twelfth aspect of the invention provides a liquid immersion system that is used by an immersion exposure, which exposes a substrate with exposure light through an optical member and a liquid, in order to fill an optical path between the optical member and the substrate with the liquid, and comprises: a first surface; a second surface, which is disposed around the first surface and adjacent to an outer edge of the first surface; and a liquid recovery surface, which is disposed around the second surface and adjacent to an outer edge of the second surface; wherein, when an object is disposed at a position at which it opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object.

A thirteenth aspect of the invention provides a liquid immersion system that is used by an immersion exposure, which exposes a substrate with exposure light through an optical member and a liquid, in order to fill an optical path between the optical member and the substrate with the liquid, and comprises: a first surface; a second surface, which is disposed adjacent to an outer edge of the first surface; and a liquid recovery surface, which is disposed at an outer side of the second surface with respect to the first surface; wherein, the liquid recovery surface comprises a third area, which is disposed at the outer side of the second surface with respect to the optical path of the exposure light, and a fourth area, which is disposed at the outer side of the third area with respect to the optical path of the exposure light; when an object is disposed at a position at which it opposes at least part of the first surface and at least part of the liquid recovery surface, a spacing between the second surface and the object is larger than a spacing between the first surface and the object, a spacing between the third area and the object is larger than the spacing between the first surface and the object, and the spacing between the fourth area and the object is smaller than the spacing between the third area and the object in a prescribed direction that is substantially perpendicular to a front surface of the object; and a size of the fourth area is larger than a size of the third area in a radial direction with respect to the optical path of the exposure light.

A fourteenth aspect of the invention provides a liquid immersion system that is used by an immersion exposure, which exposes a substrate with exposure light through an optical member and a liquid, in order to fill an optical path between the optical member and the substrate with the liquid, and comprises: a first surface; a second surface, which is disposed adjacent to an outer edge of the first surface; and a liquid recovery surface, which is disposed at an outer side of the second surface with respect to the first surface; wherein, the liquid recovery surface comprises a third area, which is disposed at the outer side of the second surface with respect to the optical path of the exposure light, which is disposed at the outer side of the third area with respect to the optical path of the exposure light; when an object is disposed at a position at which it opposes at least part of the first surface and at least part of the liquid recovery surface, a spacing between the second surface and the object is larger than a spacing between the first surface and the object, a spacing between the third area and the object is larger than the spacing between the first surface and the object, and the spacing between the fourth area and the object is smaller than the spacing between the third area and the object in a prescribed direction that is substantially perpendicular to a front surface of the object; and a suction force at the fourth area is different than a suction force at the third area.

A fifteenth aspect of the invention provides an exposing method that comprises the steps of: using a liquid immersion system according to the eleventh through fourteenth aspects of the invention to fill a space between a substrate and an optical member of the immersion exposure apparatus with a liquid; and radiating an exposure light to the substrate through the optical member and the liquid.

A sixteenth aspect of the invention provides a device fabricating method that comprises the steps of: exposing a substrate using an exposing method according to the fifteenth aspect of the invention; and developing the exposed substrate.

A seventeenth aspect of the invention provides a liquid immersion system used in a liquid immersion exposure, comprising: an opening through which exposure light passes, the exposure light being emitted from an emergent surface of an optical element, the opening being disposed below the emergent surface of the optical element; a first surface disposed around the opening, the first surface facing a predetermined reference surface, the reference surface intersecting with an optical path of the exposure light, which has been passed through the opening; a supply port from which a liquid is supplied to a space between the emergent surface of the optical element and the opening; a recess with respect to the first surface, the recess being disposed far from the opening than the first surface, the recess having a depth along a direction leading away from the reference surface; a wall by which the recess is formed; a first liquid recovery portion at which the liquid can be recovered, the first liquid recovery portion being provided at least a part of the wall; and a second liquid recovery portion at which the liquid can be recovered, the second liquid recovery portion being far from the opening than the recess.

The some aspects of the present invention can fill an optical path space of exposure light with a liquid in a desired state, thereby preventing exposure failures from occurring and defective devices from being produced.

### BRIEF DESCRIPTION OF THE DRAWINGS

FIG. 1 is a schematic block diagram that shows an exposure apparatus according to a first embodiment.

FIG. 2 is a side cross sectional view that shows the vicinity of a liquid immersion member according to the first embodiment.

FIG. 3 is a partial, broken, schematic, oblique view that shows the liquid immersion member according to the first embodiment.

FIG. 4 is an oblique view that shows the liquid immersion member according to the first embodiment, viewed from the lower side.

FIG. 5 is a partial, enlarged, side cross sectional view of the liquid immersion member according to the first embodiment.

FIG. 6 is a schematic drawing for explaining the action of the liquid immersion member according to a modified example.

FIG. 7 is a schematic drawing for explaining the action of the liquid immersion member according to the first embodiment.

FIG. 8 is a schematic drawing for explaining the action of the liquid immersion member according to the first embodiment.

FIG. 9 is a schematic diagram for explaining another example of the liquid immersion member according to the first embodiment.

FIG. 10 is a schematic diagram for explaining another example of the liquid immersion member according to the first embodiment.

FIG. 11 is a schematic diagram for explaining another example of the liquid immersion member according to the first embodiment.

FIG. 12 is a schematic diagram for explaining another example of the liquid immersion member according to the first embodiment.

FIG. 13 is a schematic diagram for explaining another example of the liquid immersion member according to the first embodiment.

FIG. 14 is a schematic diagram for explaining another example of the liquid immersion member according to the first embodiment.

FIG. 15 is a schematic diagram for explaining another example of the liquid immersion member according to the first embodiment.

FIG. 16 is a partial, enlarged, side cross sectional view of the liquid immersion member according to a second embodiment.

FIG. 17 is an oblique view that shows the liquid immersion member according to a third embodiment, viewed from the lower side.

FIG. 18 is a partial, enlarged, side cross sectional view of the liquid immersion member according to the third embodiment.

FIG. 19 is a partial, enlarged, side cross sectional view of the liquid immersion member according to the third embodiment.

FIG. 20 is a partial, enlarged, side cross sectional view of the liquid immersion member according to the third embodiment.

FIG. 21 is a flow chart diagram that depicts one example of a process of fabricating a microdevice.

### DESCRIPTION OF EMBODIMENTS

The following explains the embodiments of the present invention referencing the drawings, but the present invention is not limited thereto. Furthermore, the following explanation defines an XYZ orthogonal coordinate system, and the positional relationships among members are explained referencing this system. Furthermore, prescribed directions within the horizontal plane are the X axial directions, the directions that are orthogonal to the X axial directions in the horizontal plane are the Y axial directions, and the directions that are orthogonal to the X axial directions and the Y axial directions (i.e., the vertical directions) are the Z axial directions. In addition, the rotational (the inclined) directions around the X, Y, and Z axes are the θX, θY, and θZ directions, respectively.

### First Embodiment

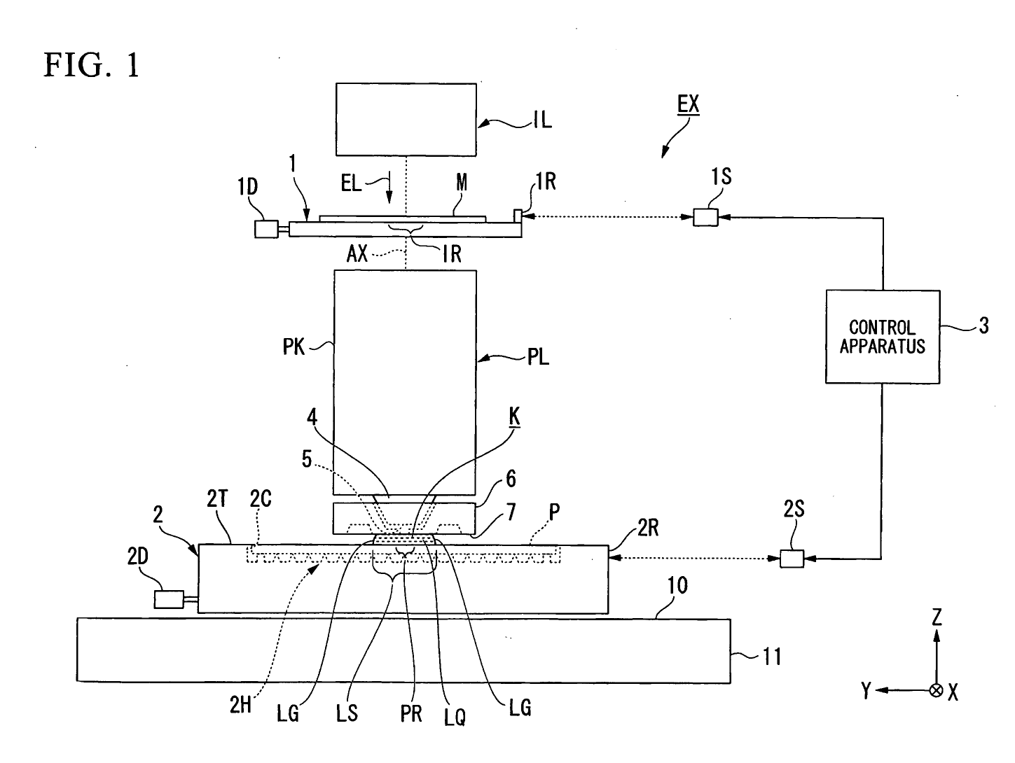

A first embodiment will now be explained. FIG. 1 is a schematic block diagram that shows one example of an exposure apparatus EX according to the first embodiment. In FIG. 1, the exposure apparatus EX comprises a movable mask stage 1 that holds a mask M, a movable substrate stage 2 that holds a substrate P, an illumination system IL, which illuminates the mask M with exposure light EL, a projection optical system PL, which projects an image of a pattern of the mask M that is illuminated by the exposure light EL onto the substrate P, and a control apparatus 3 that controls the operation of the entire exposure apparatus EX.

Furthermore, the substrate P referenced herein is a substrate for fabricating a device and includes a substrate wherein a photosensitive film is formed on a base material such as a semiconductor wafer, e.g., a silicon wafer. The photosensitive film is a film of a photosensitive material (photoresist). Various films, such as a protective film (topcoat film), may be formed on the substrate P in addition to the photosensitive film. The mask M includes a reticle wherein a device pattern that is to be projected to the substrate P is formed, e.g., one wherein a prescribed pattern is formed using a light shielding film of chrome or the like, on a transparent plate member such as a glass plate. This light transmitting type mask is not limited to a binary mask wherein a pattern is formed with a light shielding film, but may also include, for example, a halftone type or a spatial frequency modulation type phase shift mask. In addition, a transmitting type mask is used as the mask M in the present embodiment, but a reflecting type mask may also be used.

In the present embodiment, the exposure apparatus EX is an immersion exposure apparatus that exposes the substrate P with the exposure light EL through a liquid LQ and forms an immersion space LS so that at least part of an optical path space K of the exposure light EL is filled with the liquid LQ. Furthermore, the optical path space K of the exposure light EL is a space that includes the optical path through which the exposure light EL passes. The immersion space LS is a space that is filled with the liquid LQ. In the present embodiment, water (pure water) is used as the liquid LQ.

In the present embodiment, the immersion space LS is formed so that the optical path space K on the image plane side of a last optical element 4, which is the optical element of a plurality of optical elements of the projection optical system PL that is closest to the image plane of the projection optical system PL, is filled with the liquid LQ. The last optical element 4 comprises an emergent surface 5 that emits the exposure light EL toward the image plane of the projection optical system PL. The immersion space LS is formed so that the optical path space K on the emergent side (the image plane side) of the last optical element 4 is filled with the liquid LQ. Specifically, the immersion space LS is formed so that the liquid LQ fills the optical path space K between the last optical element 4 and an object that is disposed at a position at which it opposes the emergent surface 5 of the last optical element 4. The position at which the object opposes the emergent surface 5 of the last optical element 4 includes a position at which the object can be irradiated by the exposure light EL.

The exposure apparatus EX comprises a liquid immersion member 6 that is capable of forming the immersion space LS. The liquid immersion member 6 is disposed in the vicinity of the last optical element 4. The liquid immersion member 6 comprises a lower surface 7. In the present embodiment, the object that is capable of opposing the emergent surface 5 of the last optical element 4 is also capable of opposing the lower surface 7 of the liquid immersion member 6. When the front surface of the object is disposed at a position at which it opposes the emergent surface 5 of the last optical element 4, the front surface of the object and at least part of the lower surface 7 of the liquid immersion member 6 are opposed. When the emergent surface 5 of the last optical element 4 and the front surface of the object are opposed, the space between the emergent surface 5 of the last optical element 4 and the front surface of the object can hold the liquid LQ therebetween. In addition, when the lower surface 7 of the liquid immersion member 6 and the front surface of the object are opposed, the space between the lower surface 7 of the liquid immersion member 6 and the front surface of the object can hold the liquid LQ therebetween. Holding the liquid LQ between the front surface of the object on one side and the emergent surface 5 of the last optical element 4 and the lower surface 7 of the liquid immersion member 6 on the other side forms the immersion space LS so that the optical path space K between the emergent surface 5 of the last optical element 4 and the front surface of the object is filled with the liquid LQ.

In the present embodiment, the object that is capable of opposing the emergent surface 5 of the last optical element 4 and the lower surface 7 of the liquid immersion member 6 includes an object that is capable of moving on the emergent side (the image plane side) of the last optical element 4, as well as an object that is capable of moving to the position at which it opposes the emergent surface 5 of the last optical element 4 and the lower surface 7 of the liquid immersion member 6. In the present embodiment, the object that is capable of opposing the emergent surface 5 of the last optical element 4 and the lower surface 7 of the liquid immersion member 6 includes at least one of the substrate stage 2 and the substrate P that is held thereby. Furthermore, to simplify the explanation, the following principally explains an exemplary state wherein the substrate P opposes the emergent surface 5 of the last optical element 4 as well as the lower surface 7 of the liquid immersion member 6.

In the present embodiment, the immersion space LS is formed so that part of the area (a local area) of the front surface of the substrate P, which is disposed at a position at which it opposes the emergent surface 5 of the last optical element 4 as well as the lower surface 7 of the liquid immersion member 6, is covered by the liquid LQ, and an interface (meniscus, edge) LG of the liquid LQ is formed between the front surface of the substrate P and the lower surface 7 of the liquid immersion member 6. Namely, the exposure apparatus EX of the present embodiment adopts a local liquid immersion system wherein the immersion space LS is formed so that part of the area on the substrate P that includes a projection region PR of the projection optical system PL is covered with the liquid LQ during the exposure of the substrate P. The state of the interface LG is not limited to the aspect shown in the figures.

The illumination system IL illuminates a prescribed illumination region IR on the mask M with the exposure light EL, which has uniform luminous flux intensity distribution. Examples of light that can be used as the exposure light EL emitted from the illumination system IL include: deep ultraviolet (DUV) light such as bright line (g-line, h-line, or i-line) light emitted from, for example, a mercury lamp, and KrF excimer laser light (248 nm wavelength); and vacuum ultraviolet (VUV) light such as ArF excimer laser light (193 nm wavelength) and F₂ laser light (157 nm wavelength). In the present embodiment, ArF excimer laser light, which is ultraviolet light (vacuum ultraviolet light), is used as the exposure light EL.

The mask stage 1, in the state wherein it holds the mask M, is movable in the X axial, Y axial, and θZ directions by a first drive system ID that comprises actuators, e.g., linear motors. Laser interferometers 1S measure positional information of the mask stage 1 (the mask M) in the X axial, Y axial, and θZ directions. The laser interferometers 1S measure the positional information using reflecting mirrors 1R, which are provided to the mask stage 1. Based on the measurement results of the laser interferometers IS, the control apparatus 3 controls the position of the mask M, which is held by the mask stage 1, by driving the first drive system 1D.

The projection optical system PL projects an image of the pattern of the mask M to the substrate P at a prescribed projection magnification. A lens barrel PK holds the plurality of optical elements of the projection optical system PL. The projection optical system PL of the present embodiment is a reduction system that has a projection magnification of, for example, ¼, ⅕, or ⅛. Furthermore, the projection optical system PL may be a reduction system, a unity magnification system or an enlargement system. In the present embodiment, an optical axis AX of the projection optical system PL is parallel to the Z axis. In addition, the projection optical system PL may be: a dioptric system that does not include catoptric elements; a catoptric system that does not include dioptric elements; or a catadioptric system that includes both catoptric elements and dioptric elements. In addition, the projection optical system PL may form either an inverted image or an erect image.

The substrate stage 2, in the state wherein it holds the substrate P, can be moved in six directions, i.e., in the X axial, Y axial, Z axial, θX, θY, and θZ directions, by a second drive system 2D that comprises actuators, e.g., linear motors. Laser interferometers 2S measure positional information of the substrate stage 2 (the substrate P) in the X axial, the Y axial, and the θZ directions. The laser interferometers 2S measure the positional information using reflecting mirrors 2R, which are provided to the substrate stage 2. In addition, a focus and level detection system (not shown) detects the surface position information (positional information in the Z axial, θX, and θY directions) of the front surface of the substrate P, which is held by the substrate stage 2. Based on the measurement results of the laser interferometers 2S and the detection results of the focus and level detection system, the control apparatus 3 controls the position of the substrate P, which is held by the substrate stage 2, by driving the second drive system 2D.

The substrate stage 2 comprises a substrate holder 2H, which holds the substrate P, and an upper surface 2T, which is disposed around the substrate holder 2H and is capable of opposing the emergent surface 5 of the last optical element 4 and the lower surface 7 of the liquid immersion member 6. The substrate holder 2H is disposed in a recessed part 2C, which is provided in the substrate stage 2. The substrate holder 2H holds the substrate P so that the front surface thereof is substantially parallel to the XY plane. The front surface of the substrate P, which is held by the substrate holder 2H, is capable of opposing the emergent surface 5 of the last optical element 4 and the lower surface 7 of the liquid immersion member 6. In addition, the upper surface 2T of the substrate stage 2 is a flat surface that is substantially parallel to the XY plane. The front surface of the substrate P, which is held by the substrate holder 2H, and the upper surface 2T of the substrate stage 2 are disposed in substantially the same plane and are substantially flush. The upper surface 2T is formed from a material that includes, for example, fluorine, and is therefore liquid repellent with respect to the liquid LQ. The contact angle of the liquid LQ with respect to the upper surface 2T is, for example, 80° or greater.

The exposure apparatus EX comprises a base plate 11, which comprises a guide surface 10 that movably supports the substrate stage 2. In the present embodiment, the guide surface 10 is substantially parallel to the XY plane. The substrate stage 2 is capable of moving along the guide surface 10 in the X and Y directions (the two dimensional directions).

In the present embodiment, the exposure apparatus EX is a scanning type exposure apparatus (a so-called scanning stepper) that projects the image of the pattern of the mask M onto the substrate P while synchronously moving the mask M and the substrate P in prescribed scanning directions. During the exposure of the substrate P, the mask M and the substrate P are moved in the prescribed scanning directions within the XY plane that intersects the optical axis AX (the optical path of the exposure light EL) of the projection optical system PL, which is substantially parallel to the Z axis. In the present embodiment, the scanning directions (the synchronous movement directions) of the substrate P are the Y axial directions and the scanning directions (the synchronous movement directions) of the mask M are also the Y axial directions. The exposure apparatus EX moves the substrate P in one of the Y axial directions with respect to the projection region PR of the projection optical system PL and radiates the exposure light EL onto the substrate P through the projection optical system PL and the liquid LQ in the immersion space LS on the substrate P while moving the mask M in one of the Y axial directions with respect to the illumination region IR of the illumination system IL synchronized to the movement of the substrate P. Thereby, the image of the pattern of the mask M is projected onto the substrate P, which is thereby exposed with the exposure light EL.

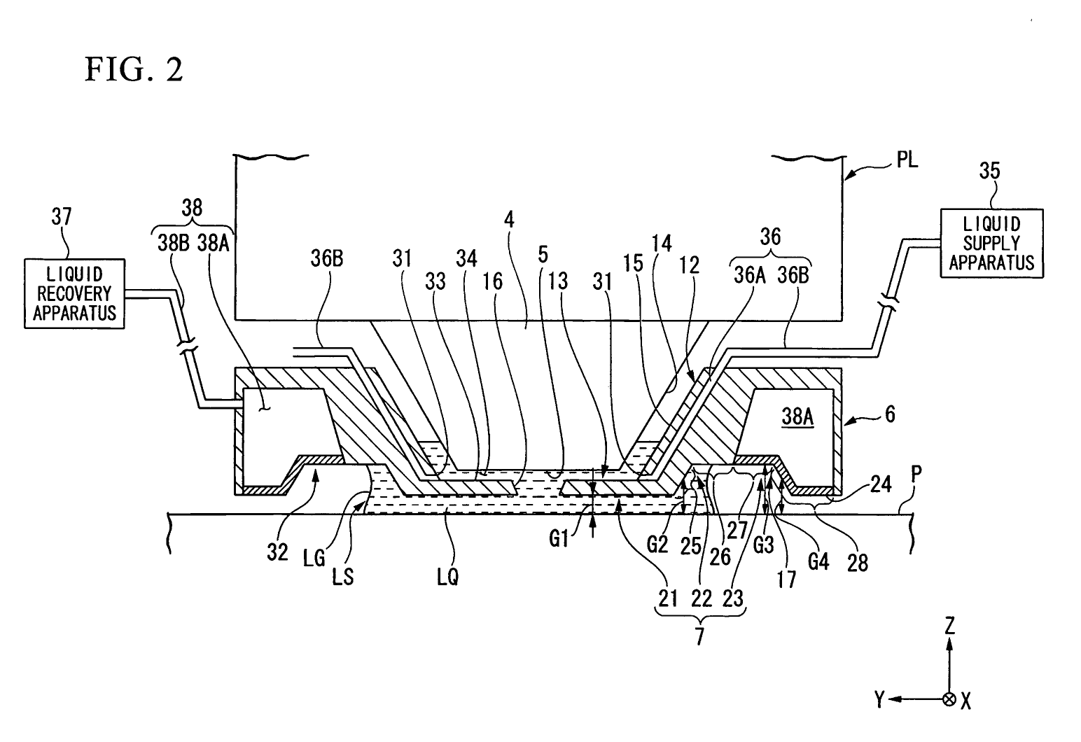

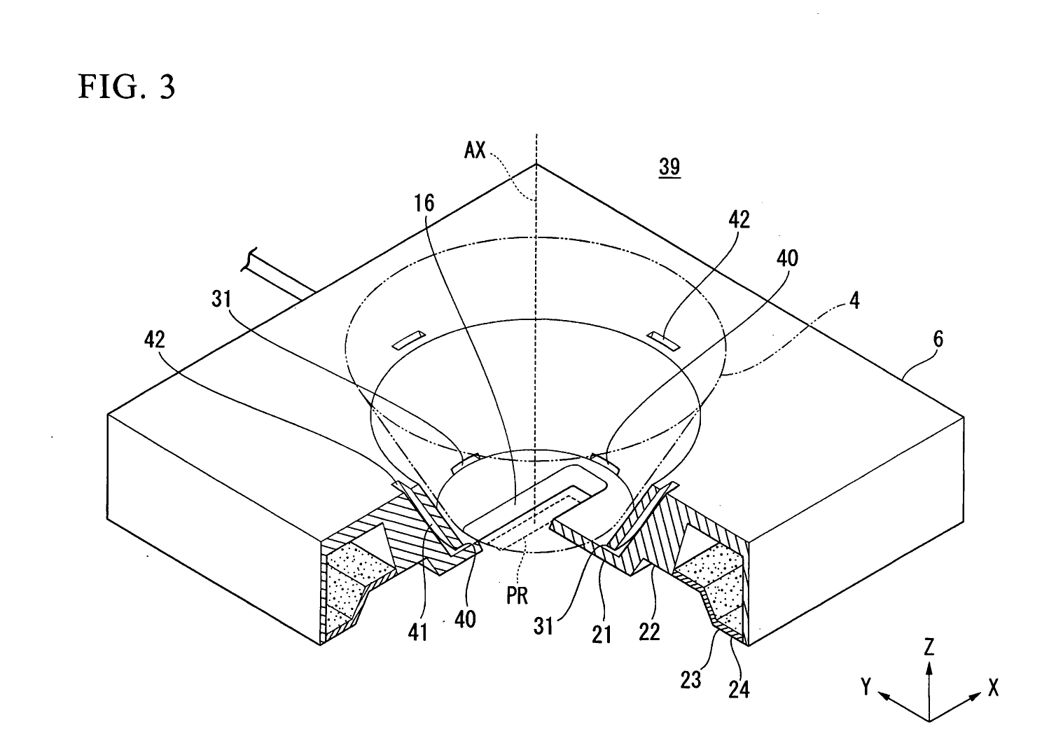

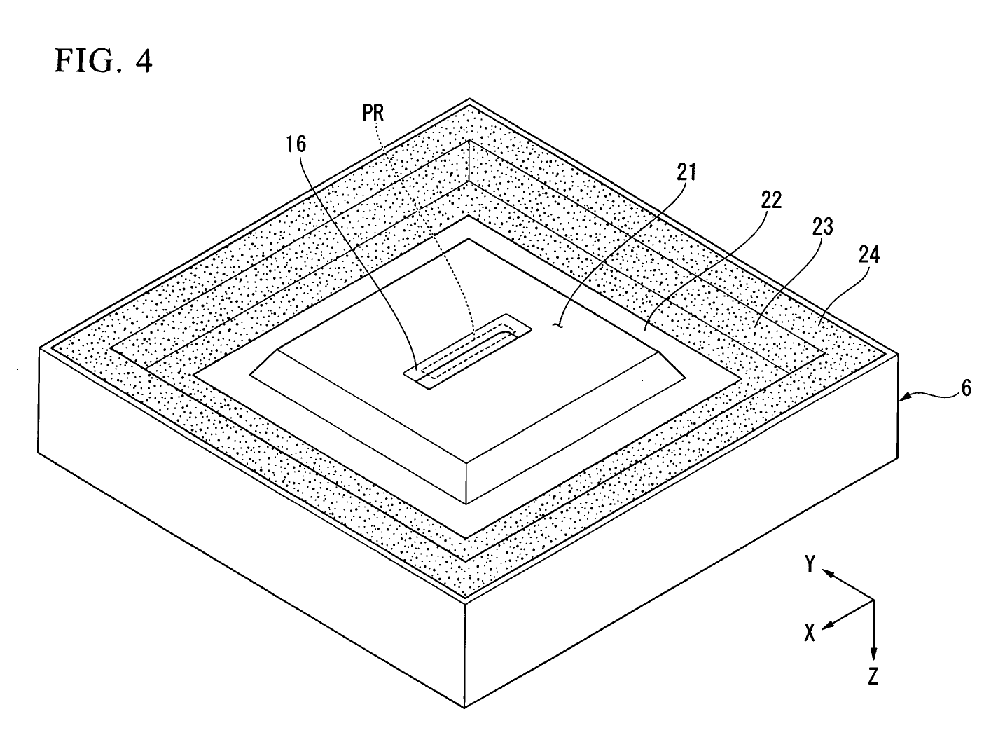

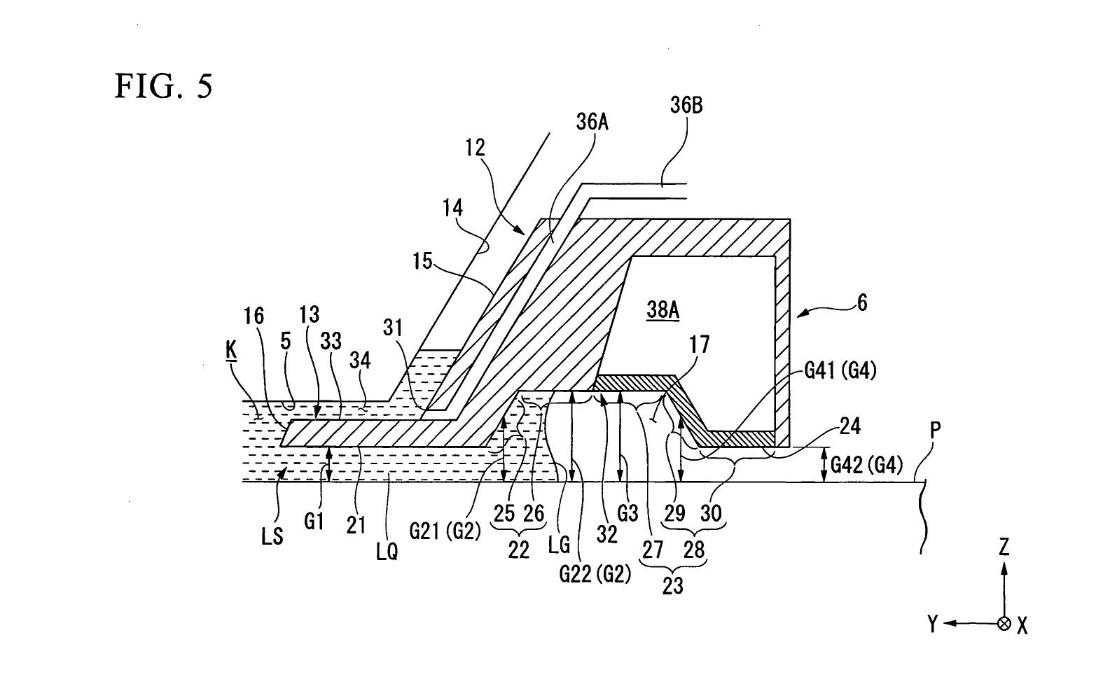

The following explains the liquid immersion member 6, referencing FIG. 2 through FIG. 5. FIG. 2 is a side cross sectional view that shows the vicinity of the liquid immersion member 6, FIG. 3 is a partial, broken, schematic, oblique view that shows the liquid immersion member 6, FIG. 4 is an oblique view of the liquid immersion member 6, viewed from the lower side; and FIG. 5 is an enlarged side cross sectional view of part of the liquid immersion member 6.

Furthermore, the following explains an exemplary case wherein the substrate P is disposed at a position at which it opposes the emergent surface 5 of the last optical element 4 as well as the lower surface 7 of the liquid immersion member 6; however, as discussed above, it is also possible to dispose an object other than the substrate P, such as the substrate stage 2, at a position at which it opposes the emergent surface 5 of the last optical element 4 as well as the lower surface 7 of the liquid immersion member 6. In addition, in the explanation below, the emergent surface 5 of the last optical element 4 is properly called the lower surface 5 of the last optical element 4.

The liquid immersion member 6 is an annular member and is disposed around the optical path of the exposure light EL. In the present embodiment, the liquid immersion member 6 comprises a side plate part 12, which is disposed around the last optical element 4, and a lower plate part 13, at least part of which is disposed between the lower surface 5 of the last optical element 4 and the front surface of the substrate P in the Z axial directions.

The side plate part 12 opposes an outer circumferential surface 14 of the last optical element 4 and has an inner circumferential surface 15 that is formed along its outer circumferential surface. The inner circumferential surface 15 of the liquid immersion member 6 is disposed so that it opposes the outer circumferential surface 14 of the last optical element 4 with a prescribed gap interposed therebetween.

The lower plate part 13 has an opening 16 at its center. The exposure light EL that emerges from the lower surface 5 of the last optical element 4 can pass through the opening 16. For example, during an exposure of the substrate P, the exposure light EL that emerges from the lower surface 5 of the last optical element 4 passes through the opening 16 and is radiated to the front surface of the substrate P through the liquid LQ. In the present embodiment, the cross sectional shape of the exposure light EL in the opening 16 is substantially rectangular (slit shaped) with the longitudinal directions in the X axial directions. The opening 16 is formed in a substantially rectangular shape (a slit shape) in the X and Y directions in accordance with the cross sectional shape of the exposure light EL. In addition, the cross sectional shape of the exposure light EL in the opening 16 and the shape of the projection region PR of the projection optical system PL on the substrate P are substantially the same.

Furthermore, the liquid immersion member 6 can be formed by one member or a plurality of members. In another embodiment, the liquid immersion member 6 can move relative to the optical element 4.

The liquid immersion member 6 comprises a first surface 21, which is disposed around the optical path of the exposure light EL, a second surface 22, which is provided on the outer sides of the first surface 21 with respect to the optical path of the exposure light EL, and a liquid recovery surface 23, which is provided on the outer sides of the second surface 22 with respect to the optical path of the exposure light EL.

The first surface 21, the second surface 22, and the liquid recovery surface 23 are provided so that they oppose the front surface of the substrate P. In the present embodiment, the lower surface 7 of the liquid immersion member 6 comprises the first surface 21, the second surface 22, and the liquid recovery surface 23.

As shown in FIG. 2 and FIG. 5, in the present embodiment, when the substrate P is disposed at a position at which it opposes the first surface 21, the second surface 22, and the liquid recovery surface 23, a spacing G2 between the second surface 22 and the front surface of the substrate P is larger than a spacing G1 between the first surface 21 and the front surface of the substrate P in the Z axial directions, and a spacing G3 between the front surface of the substrate P and a part (a third area 27 as described hereinafter) of the liquid recovery surface 23 is greater than the spacing G1 between the first surface 21 and the front surface of the substrate P. Furthermore, as discussed above, the substrate holder 2H holds the substrate P so that the front surface thereof and the XY plane are substantially parallel. Alternatively or also, in the embodiment, the XY plane at which the front surface of the substrate P is disposed (or the XY plane at which the image plane of the projection optical system PL is positioned) can be set as a reference surface, and the spacing between the front surface of the substrate P and the lower surface 7 of the liquid immersion member 6 can be assumed as the spacing between the reference surface and the lower surface 7 of the liquid immersion member 6. For example, the spacing G1 can be assumed as the spacing between the first surface 21 and the reference surface.

In the present embodiment, the liquid immersion member 6 comprises a recessed part 17 (or a recess), which is positioned on the outer sides of the first surface 21 with respect to the optical path of the exposure light EL. The second surface 22 and at least part of the liquid recovery surface 23 are disposed at the inner side of the recessed part 17.

The recessed part 17 is recessed with respect to the first surface 21, and has a depth along a direction leading away from the front surface of the substrate P. In the embodiment, the recessed part 17 is formed by walls including a part of the liquid recovery surface 23 and the second surface 22. In the embodiment, the surface of the wall of the recessed part 17 is substantially continuous. In another embodiment, the surface of the wall of the recessed part 17 is substantially intermittent. In the embodiment, the surface of the wall of the recessed part 17 includes a substantially continuous surface extending from the outer edge of the first surface 21, and a part of the liquid recovery surface 23 is provided in a part of the continuous surface. The continuous surface includes a plurality of positions where the distances between the continuous surface and the front surface of the substrate P (reference surface) are different from each other.

The first surface 21 is disposed around the optical path of the exposure light EL. The space between the first surface 21 and the front surface of the substrate P is capable of holding the liquid LQ. In the present embodiment, the first surface 21 is substantially flat and substantially parallel to the front surface of the substrate P (the XY plane). In the present embodiment, the external shape of the first surface 21 within the XY plane is rectangular, but it may be some other shape, e.g., circular. In another embodiment, the first surface 21 can be non-parallel to the XY plane.

In the present embodiment, the first surface 21 includes the lower surface of the lower plate part 13. The first surface 21 is disposed around the opening 16.

The second surface 22 is disposed at the outer sides of the first surface 21 with respect to the optical path of the exposure light EL. The space between the second surface 22 and the front surface of the substrate P is capable of holding the liquid LQ. The second surface 22 is provided so that it adjoins the outer edges of the first surface 21. In the present embodiment, the second surface 22 is disposed around the optical path of the exposure light EL. Namely, the second surface 22 is disposed around the first surface 21.

The liquid recovery surface 23 is disposed at the outer sides of the second surface 22 with respect to the optical path of the exposure light EL. The liquid recovery surface 23 is capable of recovering the liquid LQ between the lower surface 7 of the liquid immersion member 6 and the front surface of the substrate P. The liquid recovery surface 23 is provided so that it adjoins the outer edges of the second surface 22. In the present embodiment, the liquid recovery surface 23 is disposed around the optical path of the exposure light EL. Namely, the liquid recovery surface 23 is disposed around the second surface 22.

The liquid recovery surface 23 is capable of recovering at least part of the liquid LQ from the space between the front surface of the substrate P on one side and the lower surface 5 of the last optical element 4 and the lower surface 7 of the liquid immersion member 6 on the other side. The liquid recovery surface 23 includes a front surface (a lower surface) of a porous member (mesh member) 24. At least part of the liquid LQ on the substrate P, which opposes the liquid recovery surface 23, is recovered via the porous member 24. The liquid recovery surface 23 is capable of recovering the liquid LQ that contacts it (the front surface of the porous member 24). The porous member 24 is a member wherein numerous, minute pores are formed through which the liquid LQ can flow. In the present embodiment, the porous member 24 is a mesh plate that is fabricated by forming the plurality of pores in a thin plate. Alternatively or also, a sintered member (e.g., sintered metal) wherein numerous pores are formed, a foam member (e.g., metal foam), or the like can be used as the porous member 24.

The second surface 22 includes a first area 25 that is inclined with respect to the first surface 21. Namely, the first area 25 is inclined with respect to the front surface of the substrate P (the XY plane). The first area 25 is inclined so that it becomes gradually spaced apart from the front surface of the substrate P in directions that lead away from the optical path of the exposure light EL. Namely, the first area 25 is inclined so that it becomes gradually spaced apart from the front surface of the substrate P in radial directions with respect to the optical axis AX. In the present embodiment, the first area 25 is disposed so that it adjoins the outer edges of the first surface 21. The first area 25 is disposed around the first surface 21. In other words, the wall of the recessed part 17 includes a gradient region (the first area 25), which increases its recessed depth gradually, along a direction leading away from the optical axis AX (the optical path).

In addition, in the present embodiment, the second surface 22 includes a second area 26, which is disposed at the outer sides of the first area 25 with respect to the optical path of the exposure light EL. In the present embodiment, the second area 26 is disposed so that it adjoins the outer edges of the first area 25. In the embodiment, the second area 26 is disposed around the first area 25. The second area 26 is substantially parallel to the first surface 21. Namely, the second area 26 is substantially parallel to the front surface of the substrate P (the XY plane). In the embodiment, the second area 26 (flat region) can be substantially flat. In another embodiment, the second area 26 can be substantially non-parallel to the first surface 21, or can be substantially non-flat.

In the present embodiment, the spacing G2 between the second surface 22 and the front surface of the substrate P includes a spacing G21 between the first area 25 and the front surface of the substrate P as well as a spacing G22 between the second area 26 and a front surface of the substrate P.

The liquid recovery surface 23 includes a third area 27, which is disposed so that it adjoins the outer edges of the second surface 22 (the second area 26). The third area 27 is disposed around the second area 26. In the present embodiment, the third area 27 is substantially parallel to the first surface 21. Namely, the third area 27 is substantially parallel to the front surface of the substrate P (the XY plane). In another embodiment, the third area 27 can be non-parallel to the first surface 21. In addition, in the present embodiment, the second area 26 of the second surface 22 and the third area 27 of the liquid recovery surface 23 are disposed in substantially the same plane and are substantially flush.

In addition, in the present embodiment, the liquid recovery surface 23 includes a fourth area 28, which is disposed at the outer sides of the third area 27 with respect to the optical path of the exposure light EL. In the present embodiment, the fourth area 28 is disposed so that it adjoins the outer edges of the third area 27. The fourth area 28 is disposed around the third area 27.

In the present embodiment, a spacing G4 between the fourth area 28 and the front surface of the substrate P is smaller than the spacing G3 between the third area 27 and the front surface of the substrate P in the Z axial directions.

In the present embodiment, the fourth area 28 includes an inclined area (sloped region) 29, which is disposed so that it adjoins the outer edges of the third area 27 and is inclined with respect to the third area 27, and a parallel area (flat region) 30, which is disposed so that it adjoins the outer edges of the inclined area 29 and is substantially parallel to the first surface 21. The inclined area 29 of the fourth area 28 is inclined so that it gradually approaches the front surface of the substrate P in the directions that lead away from the optical path of the exposure light EL. The parallel area 30 of the fourth area 28 is substantially parallel to the front surface of the substrate P (the XY plane). Namely, the inclined area 29 of the fourth area 28 is inclined so that it becomes gradually close to the front surface of the substrate P in the radial directions with respect to the optical axis AX.

In other words, the wall (continuous surface) of the recessed part 17 includes a gradient region (the inclined area 29), which shallows gradually, along a direction leading away from the optical axis AX (the optical path). In the embodiment, the extended length of the inclined area 29 along its gradient direction is substantially equal to the extended length of the first area 25 along its gradient direction. In another embodiment, the extended length of the inclined area 29 along its gradient direction can be greater or smaller than the extended length of the first area 25 along its gradient direction. Furthermore, in the embodiment, the absolute gradient value of the inclined area 29 (e.g., an averaged angle with respect to the first surface 21) is substantially equal to the absolute gradient value of the first area 25. In another embodiment, the absolute gradient value of the inclined area 29 can be greater or smaller than the absolute gradient value of the first area 25.

The spacing G4 between the fourth area 28 and the front surface of the substrate P includes a spacing G41 between the inclined area 29 and the front surface of the substrate P and a spacing G42 between the parallel area 30 and the front surface of the substrate P.

In the present embodiment, the spacing G42 between the parallel area 30 of the fourth area 28 and the front surface of the substrate P is substantially equal to the spacing G1 between the first surface 21 and the front surface of the substrate P in the Z axial directions. In another embodiment, the spacing G42 and the spacing G1 are substantially different from each other.

The exposure apparatus EX comprises supply ports 31 that supply the liquid LQ and a recovery port 32 that recovers the liquid LQ. In the present embodiment, the supply ports 31 and the recovery port 32 are provided to the liquid immersion member 6.

The supply ports 31 are disposed in the vicinity of the optical path space K and are capable of supplying the liquid LQ to the optical path space K. The supply ports 31 supply the liquid LQ in order to form the immersion space LS. The supply ports 31 are capable of supplying the liquid LQ to the space between the front surface of the substrate P on one side and the lower surface 5 of the last optical element 4 and the lower surface 7 of the liquid immersion member 6 on the other side.

In the present embodiment, the liquid immersion member 6 is disposed around the optical path of the exposure light EL and has an upper surface 33 that opposes the lower surface 5 of the last optical element 4 with a prescribed gap interposed therebetween. The supply ports 31 are disposed in the vicinity of a prescribed space 34 between the lower surface 5 of the last optical element 4 and the upper surface 33. The supply ports 31 are disposed so that they are connected to the prescribed space 34 and are capable of supplying the liquid LQ thereto. Namely, the supply ports 31 can supply the liquid LQ to the space 34 disposed above the opening 16. In addition, in the present embodiment, the supply ports 31 are provided on opposite sides of the optical path space K in the Y axial directions (one on each side). In the explanation below, the prescribed space 34 is properly called the interior space 34.

In the present embodiment, the upper surface 33 includes the upper surface of the lower plate part 13. The upper surface 33 is flat and is substantially parallel to the XY plane. The upper surface 33 is disposed around the opening 16.

In addition, the exposure apparatus EX comprises a liquid supply apparatus 35. The liquid supply apparatus 35 is capable of feeding the pure, temperature adjusted liquid LQ. The supply ports 31 are connected to the liquid supply apparatus 35 via passageways 36. Each passageway 36 comprises a supply passageway 36A, which is formed inside the liquid immersion member 6, and a passageway 36B, which is formed from a supply pipe that connects the supply passageway 36A and the liquid supply apparatus 35. The liquid LQ that is fed from the liquid supply apparatus 35 is supplied to each of the supply ports 31 through the corresponding passageway 36. The supply ports 31 supply the liquid LQ from the liquid supply apparatus 35 to the optical path space K.

The recovery port 32 is capable of recovering the liquid LQ by suctioning it. The porous member 24 is disposed in the recovery port 32 and forms the liquid recovery surface 23. In the present embodiment, the porous member 24 is a plate shaped member, and the liquid recovery surface 23 is formed from one porous member 24 (a single sheet thereof). Namely, in the present embodiment, the porous member 24 has bent portions. In another embodiment, the porous member 24 can be formed from a plurality of porous members.

In addition, the exposure apparatus EX comprises a liquid recovery apparatus 37. The liquid recovery apparatus 37 includes a vacuum system and is capable of recovering the liquid LQ by suctioning it. The recovery port 32 (the liquid recovery surface 23) and the liquid recovery apparatus 37 are connected via a passageway 38. The passageway 38 comprises a recovery passageway 38A, which is formed inside the liquid immersion member 6, and a passageway 38B, which is formed from a recovery pipe that connects the recovery passageway 38A and the liquid recovery apparatus 37. In the present embodiment, the control apparatus 3 recovers the liquid LQ via the porous member 24 (the liquid recovery surface 23) by operating the liquid recovery apparatus 37, which includes the vacuum system, so as to create a pressure differential between the upper surface and the lower surface of the porous member 24. The liquid LQ that is recovered from the liquid recovery surface 23 is recovered by the liquid recovery apparatus 37 through the passageway 38.

In addition, as shown in FIG. 3, the liquid immersion member 6 comprises exhaust ports 40, which are for establishing communication between the interior space 34 and an exterior space 39. The exhaust ports 40 are disposed in the vicinity of the interior space 34. The exhaust ports 40 are disposed so that they connect to the interior space 34 and are capable of exhausting the gas therefrom. In addition, in the present embodiment, the exhaust ports 40 are provided on opposite sides (one on each side) of the optical path space K in the X axial directions.

The exhaust ports 40 are connected to exhaust passageways 41, which are formed inside the liquid immersion member 6. An opening 42 at the upper end of each of the exhaust passageways 41 is disposed at a position at which it is capable of contacting the gas of the exterior space 39 (the ambient environment) around the liquid immersion member 6 (the immersion space LS). The gas of the exterior space 39 can flow into the openings 42. The openings 42 are disposed at the +Z side of the exhaust ports 40 at positions at which they do not oppose the front surface of the substrate P. The openings 42 are disposed at positions at which they cannot contact the liquid LQ of the immersion space LS, and therefore the liquid LQ of the immersion space LS does not flow into the openings 42.

The gas of the exterior space 39 can flow into the interior space 34 via the exhaust passageways 41, and the gas of the interior space 34 can flow out to the exterior space 39 via the exhaust passageways 41. In the present embodiment, the gas can flow continuously back and forth between the interior space 34 and the exterior space 39 (the atmospheric space), which is outside of the interior space 34, via the exhaust passageways 41. The interior space 34 is open to the atmosphere via the exhaust passageways 41.

Furthermore, herein, the supply ports 31 are provided on opposite sides (one on each side) of the optical path space K in the Y axial directions, and the exhaust ports 40 are provided on opposite sides (one on each side) of the optical path space K in the X axial directions; however, the supply ports 31 may be provided on opposite sides of the optical path space K in the X axial directions, and the exhaust ports 40 may be provided on opposite sides of the optical path space K in the Y axial directions. In another embodiment, the exhaust ports 40 can be eliminated. In this case, alternatively or also, supply ports can be provided at opposite sides (one on each side) of the optical path space K in the X axial directions. Furthermore, in another embodiment, the number of the supply ports can be one.

When the substrate P is disposed at a position at which it opposes the lower surface 7 of the liquid immersion member 6, the space between the first surface 21 and the front surface of the substrate P can hold the liquid LQ. In the present embodiment, at least the first surface 21 of the liquid immersion member 6 is lyophilic. For example, the contact angle of the liquid LQ with respect to the first surface 21 can be equal to or less than about 90, 80, 70, 60, 50, 40, 30, 20, 10°. The contact angle can preferably be equal to or less than 40°, and more preferably be equal to or less than 20°. The first surface 21 can maintain contact with the liquid LQ of the immersion space LS even if the substrate P is moved in the X and Y directions. The first surface 21 maintains contact with the liquid LQ of the immersion space LS at least during the exposure of the substrate P.

In addition, the second surface 22 is capable of contacting the liquid LQ on the substrate P, and the space between the second surface 22 and the front surface of the substrate P can hold the liquid LQ when the substrate P is disposed at a position at which it opposes the lower surface 7 of the liquid immersion member 6. In addition, in the present embodiment, the second surface 22 is also lyophilic with respect to the liquid LQ. For example, the contact angle of the liquid LQ with respect to the second surface 22 can be equal to or less than about 90, 80, 70, 60, 50, 40, 30, 20, 10°. The contact angle can preferably be equal to or less than 40°, and more preferably be equal to or less than 20°.

In addition, as discussed above, the liquid LQ that contacts the liquid recovery surface 23 is recovered thereby.

FIG. 2 and FIG. 5 show a state wherein part of the liquid LQ on the substrate P is held between the substrate P on one side and the first surface 21 and part of the area of the second surface 22 on the other side. For example, during the exposure of the substrate P, the immersion space LS is formed by holding the liquid LQ between the front surface of the substrate P and the lower surface 7 of the liquid immersion member 6, which comprises the first surface 21 and the second surface 22.

The following explains a method of using the exposure apparatus EX that has the above mentioned configuration to perform an immersion exposure on the substrate P.

To form the immersion space LS, the control apparatus 3 supplies the liquid LQ to the optical path space K of the exposure light EL using the supply ports 31. When the liquid LQ is to be supplied, the control apparatus 3 disposes the object, e.g., the substrate P (the substrate stage 2), at a position at which it opposes the lower surface 5 of the last optical element 4 and the lower surface 7 of the liquid immersion member 6. The liquid LQ that is fed from the liquid supply apparatus 35 is supplied to each of the supply ports 31 through the corresponding passageway 36. The supply ports 31 supply the liquid LQ to the interior space 34. The liquid LQ from the supply ports 31 flows through the interior space 34 and into the space, which includes the space between the front surface of the substrate P and the first surface 21 and which is disposed below the opening 16, via the opening 16, and at least a part of the liquid is held between the front surface of the substrate P and the first surface 21. In addition, at least part of the liquid LQ flows into the space between the second surface 22 and the front surface of the substrate P and is held therebetween.

In so doing, the immersion space LS is formed so that the interior space 34 and the space between the front surface of the substrate P and the first surface 21 are filled with the liquid LQ, and so that the optical path space K between the front surface of the substrate P and the lower surface 5 of the last optical element 4 is filled with the liquid LQ.

In addition, in the present embodiment, the control apparatus 3 performs the liquid recovery operation, wherein the liquid recovery surface 23 (recovery port 32) is used, in parallel with performance of the liquid supply operation, wherein the supply ports 31 are used. At least part of the liquid LQ that contacts the liquid recovery surface 23 is suctioned through the porous member 24, which forms the liquid recovery surface 23. The control apparatus 3 performs the liquid supply operation and the liquid recovery operation in parallel, and therefore can continuously and locally form the immersion area (the liquid immersion space LS) on part of the front surface of the substrate P with the liquid LQ that has desired conditions (e.g., temperature and cleanliness level).

After the immersion space LS has been formed, the control apparatus 3 starts the exposure of the substrate P. As discussed above, the exposure apparatus EX of the present embodiment is a scanning type exposure apparatus. The control apparatus 3 radiates the exposure light EL onto the substrate P through the projection optical system PL and the liquid LQ on the substrate P while the front surface of the substrate P moves in one of the Y axial directions with respect to the optical path of the exposure light EL and the immersion space LS in a state wherein the immersion space LS is formed by holding the liquid LQ between the front surface of the substrate P on one side and the lower surface 5 of the last optical element 4 and the lower surface 7 of the liquid immersion member 6 on the other side. Thereby, the image of the pattern of the mask M is projected onto the substrate P, which is thereby exposed with the exposure light EL.

In addition, in order to start the exposure of a second shot region after the exposure of, for example, a first shot region on the substrate P is complete, the control apparatus 3 performs an operation wherein the front surface of the substrate P is moved in one of the X axial directions (or a direction that is inclined with respect to the X axial directions within the XY plane) in a state wherein the immersion space LS is formed.

In the present embodiment, the second surface 22 is provided so that it maintains contact with the liquid LQ that is present between the second surface 22 and the front surface of the substrate P. In the present embodiment, the shape and the surface state of the second surface 22 are adjusted (optimized) so that the liquid LQ that is present between the second surface 22 and the front surface of the substrate P maintains contact with the second surface 22, even if the substrate P is moved in the X and Y directions in the state wherein the immersion space LS is formed between the front surface of the substrate P on one side and the lower surface 5 of the last optical element 4 and the lower surface 7 of the liquid immersion member 6 on the other side. The adjustment of the shape of the second surface 22 includes the adjustment of at least one of the inclination angle of the first area 25 and the spacing G22 between the second area 26 and the front surface of the substrate P. In addition, the adjustment of the surface state of the second surface 22 includes the adjustment of the contact angle of the liquid LQ with respect to the second surface 22.

In addition, in the present embodiment, immersion conditions are set so that at least part of the space on the inner side of the recessed part 17 of the liquid immersion member 6 is filled with the liquid LQ. In the present embodiment, the immersion conditions are set so that the interface (meniscus, edge) LG of the liquid LQ of the immersion space LS is formed in the vicinity of a boundary between the second surface 22 of the liquid immersion member 6 and the liquid recovery surface 23 when the substrate P is stationary with respect to the liquid immersion member 6. The immersion conditions include the amount of liquid LQ supplied per unit of time by the supply ports 31, the amount of the liquid LQ recovered per unit of time from the recovery port 32, and the like.

The present embodiment provides the recessed part 17, which includes the second surface 22 and the liquid recovery surface 23; therefore, even if the front surface of the substrate P is moved in the X and Y directions with respect to the immersion space LS, the liquid LQ between the lower surface 7 of the liquid immersion member 6 and the front surface of the substrate P is prevented from leaking to the outer side of the space between the lower surface 7 of the liquid immersion member 6 and the front surface of the substrate P. In addition, the liquid LQ (a film, a drop, or the like of the liquid LQ) is prevented from remaining on the front surface of the substrate P. Thus, the provision of the recessed part 17, which includes the second surface 22 and the liquid recovery surface 23, to the liquid immersion member 6 is in accordance with the findings of the inventor as discussed below.

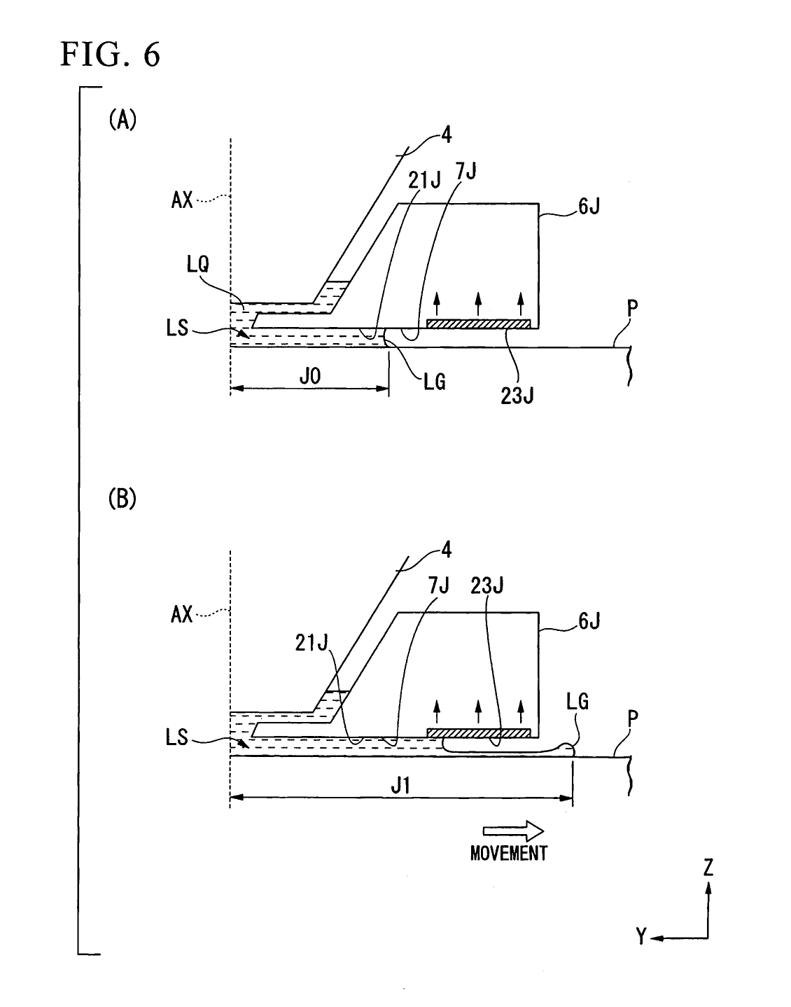

FIG. 6 includes schematic drawings that show a liquid immersion member 6J according to a comparative example. A recessed part is not formed in the liquid immersion member 6J shown in FIG. 6, and a lower surface 7J is substantially parallel to the front surface of the substrate P. Part (A) of FIG. 6 is a view that shows the state wherein the immersion space LS is formed between the liquid immersion member 6J and the substrate P, which is in the state wherein it is stationary with respect to the liquid immersion member 6J. The immersion area on the substrate P has a prescribed size J0 within the XY plane.

Furthermore, for the sake of simplicity in the explanation below, a distance between a position at which the optical axis AX of the projection optical system PL and the front surface of the substrate P intersect and a position at which a tip of the interface LG of the liquid LQ and the front surface of the substrate P intersect in prescribed directions (herein, the Y axial directions) is set to the size J0 of the immersion area within the XY plane.

If the substrate P is moved at high speed in one direction (here, the −Y direction) within the XY plane with respect to the liquid immersion member 6J, then there are cases, as shown in Part (B) of FIG. 6, wherein part of the liquid LQ between the lower surface 7J of the liquid immersion member 6J and the substrate P forms a thin film on the substrate P, or wherein the liquid LQ on the substrate P leaks to the outer side of a liquid recovery surface 23J; specifically, to the front side (the −Y side) of the substrate P in its direction of travel. Namely, there is a possibility that a size J1 of the immersion area will increase greatly due to the movement of the substrate P.

This phenomenon occurs because the liquid LQ in the vicinity of the lower surface 7J of the liquid immersion member 6J between the lower surface 7J of the liquid immersion member 6J and the front surface of the substrate P flows upward (in the +Z direction) due to the suction operation of the liquid recovery surface 23J, and is then recovered by the liquid recovery surface 23J, while the liquid LQ that is in the vicinity of the front surface of the substrate P is not recovered by the liquid recovery surface 23J as a result of, for example, surface tension with respect to the substrate P, and therefore forms a thin film on the substrate P and, as the substrate P moves, is drawn to the outer side of the liquid recovery surface 23J at the front side of the substrate P in its direction of travel. If such a phenomenon occurs, then the liquid LQ that is drawn to the outer side of the liquid recovery surface 23J forms, for example, a drop that remains on the substrate P, which leads to pattern defects and the like. Furthermore, such a phenomenon tends to occur as the travel speed of the substrate P increases, which was further clarified by the findings of the inventor.

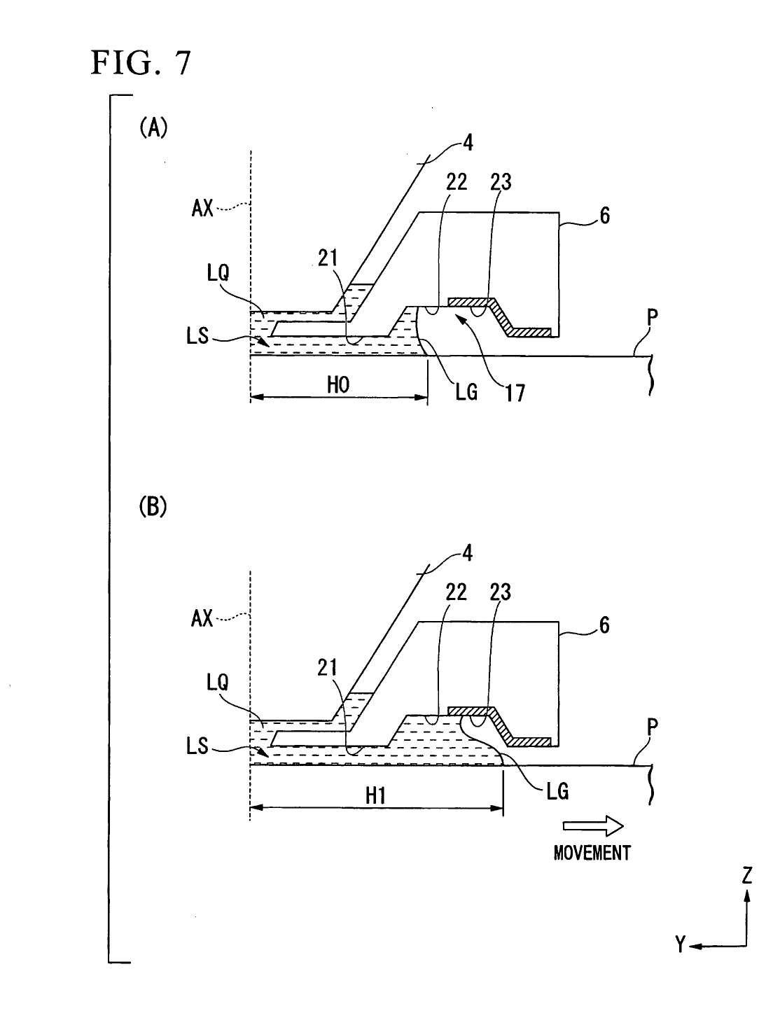

FIG. 7 includes schematic drawings that show the liquid immersion member 6 according to the present embodiment. Part (A) of FIG. 7 is a view that shows one example of the state wherein the immersion space LS is formed between the liquid immersion member 6 and the substrate P, which is in the state wherein it is stationary with respect to the liquid immersion member 6. In part (A) of FIG. 7, the interface LG of the liquid LQ is formed between the first surface 21 and the second surface 22. In the present embodiment, the liquid recovery surface 23 is provided continuous with the second surface 22, which makes it possible to form the interface LG of the liquid LQ in the vicinity of the boundary between the second surface 22 and the liquid recovery surface 23 when the object, e.g., the substrate P, is stationary with respect to the liquid immersion member 6.

The immersion area on the substrate P shown in part (A) of FIG. 7 has a prescribed size H0 within the XY plane. Here, the size H0 of the immersion area on the substrate P within the XY plane shown in part (A) of FIG. 7 and the size J0 of the immersion area on the substrate P within the XY plane shown in part (A) of FIG. 6 are equal.

Because the recessed part 17 is formed in the liquid immersion member 6 according to the present embodiment as shown in part (A) of FIG. 7, the volume of the immersion space LS shown in part (A) of FIG. 7 is greater than that of the immersion space LS shown in part (A) of FIG. 6, even if the size J0 of the immersion space LS within the XY plane shown in part (A) of FIG. 7 and the size H0 of the immersion space LS within the XY plane shown in part (A) of FIG. 6 are equal. In other words, the weight of the liquid LQ of the immersion space LS shown in part (A) of FIG. 7 is greater than that of the liquid LQ of the immersion space LS shown in part (A) of FIG. 6.

Part (B) of FIG. 7 shows the state of the immersion space LS when the substrate P is moved at high speed in the −Y direction with respect to the immersion space LS, which is formed using the liquid immersion member 6 according to the present embodiment. In the present embodiment, the liquid LQ of the immersion space LS is heavy, which makes it possible to prevent the liquid LQ of the immersion space LS from moving (i.e., to prevent the immersion space LS from expanding) and to prevent a size Hi of the immersion area (immersion space LS) on the substrate P within the XY plane from increasing, even if the substrate P is moved with respect to the immersion space LS.

Namely, by increasing the weight of the liquid LQ of the immersion space LS, it is possible to make use of the law of inertia to prevent the liquid LQ of the immersion space LS from moving, even if the substrate P is moved. In other words, increasing the weight of the liquid LQ increases the force by which the liquid LQ is pooled at that position, which makes it possible to prevent the liquid LQ from spreading (to prevent the size H1 of the immersion area from increasing) more so than the case shown in part (B) of FIG. 6, even if, for example, the substrate P is moved in the −Y direction by the same distance as that in part (B) of FIG. 6. Accordingly, it is possible to prevent part of the liquid LQ on the substrate P from assumes the shape of a film or a drop on the outer side of the space between the liquid immersion member 6 and the substrate P.

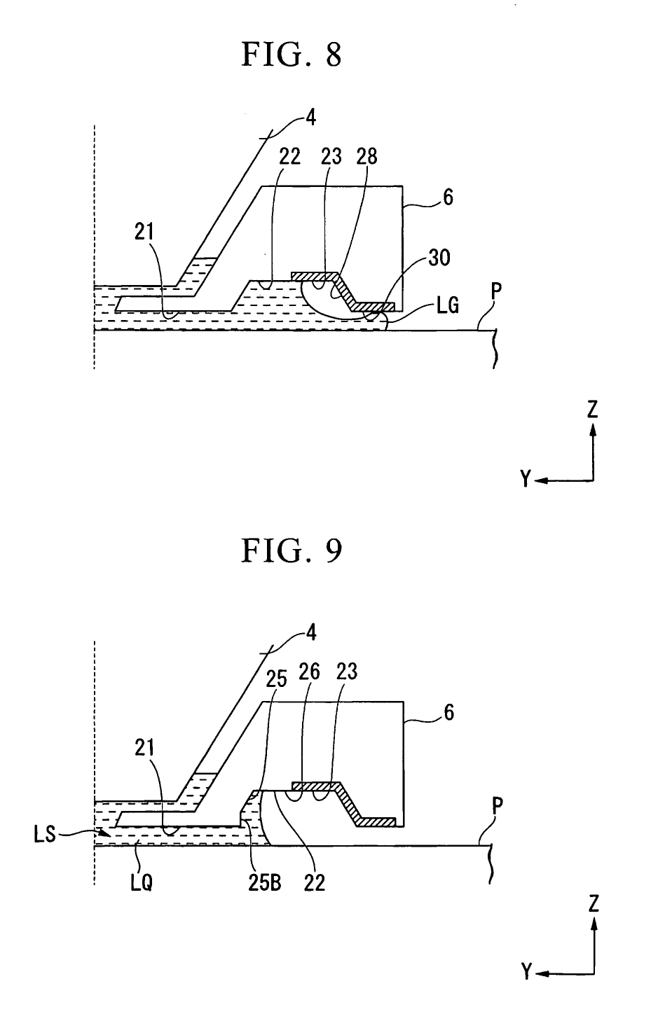

In addition, as shown in FIG. 8, it is possible to recover the liquid LQ at the fourth area 28 of the liquid recovery surface 23, even if the liquid LQ on the substrate P between the liquid immersion member 6 and the substrate P forms a film. As discussed above, in the present embodiment, the spacing G3 between the surface of the third area 27 and the front surface of the substrate P is larger than the spacing G1 between the first surface 21 and the front surface of the substrate P. Accordingly, even if part of the liquid LQ on the substrate P forms a film as shown in FIG. 8, the film is comparatively thick (e.g., thicker than the film on the substrate P that was explained referencing part (B) of FIG. 6). Accordingly, as shown in FIG. 8, the liquid LQ that forms a film on the substrate P can be recovered at the fourth area 28, which is provided at a position at which it is closer to the substrate P than the third area 27 of the liquid recovery surface 23 is. In particular, the spacing G42 between the parallel area 30 of the fourth area 28 and the front surface of the substrate P is substantially equal to the spacing G1 between the first surface 21 and the front surface of the substrate P, and the parallel area 30 of the fourth area 28 is disposed at a position at which it is close to the front surface of the substrate P, and therefore the liquid LQ that forms a film on the substrate P can be recovered satisfactorily. Accordingly, it is possible to prevent the liquid LQ from leaking to the outer side of the space between the liquid immersion member 6 and the substrate P.

In addition, the liquid recovery surface 23 of the present embodiment is provided so that it is continuous with the third area 27, the inclined area 29 of the fourth area 28, and the parallel area 30 of the fourth area 28, which makes it possible to recover the liquid LQ between the liquid recovery surface 23 and the substrate P more reliably.

As explained above, the present embodiment can prevent the liquid LQ from, for example, leaking or remaining behind, and therefore can prevent exposure failures from occurring. In addition, the travel speed of the substrate P can be increased while at the same time preventing exposure failures from occurring. Accordingly, satisfactory devices can be fabricated with good productivity.

In the present embodiment, the weight of the liquid LQ of the immersion space LS can be increased while preventing the immersion space LS from enlarging within the XY plane. Accordingly, it is possible to prevent the liquid LQ from, for example, leaking or remaining behind while preventing, for example, the liquid immersion member 6, the substrate stage 2 and, in turn, the entire exposure apparatus EX from enlarging.

Furthermore, in the present embodiment discussed above, the first area 25 of the second surface 22, which is inclined with respect to the first surface 21, is disposed so that it adjoins the outer edges of the first surface 21; however, as shown in FIG. 9 for example, a perpendicular area 25B that is perpendicular to the first surface 21 may be disposed between the first surface 21 and the first area 25. In the example shown in FIG. 9 as well, it is possible to increase the weight of the liquid LQ of the immersion space LS and thereby to prevent the liquid LQ from leaking, remaining behind, and the like.

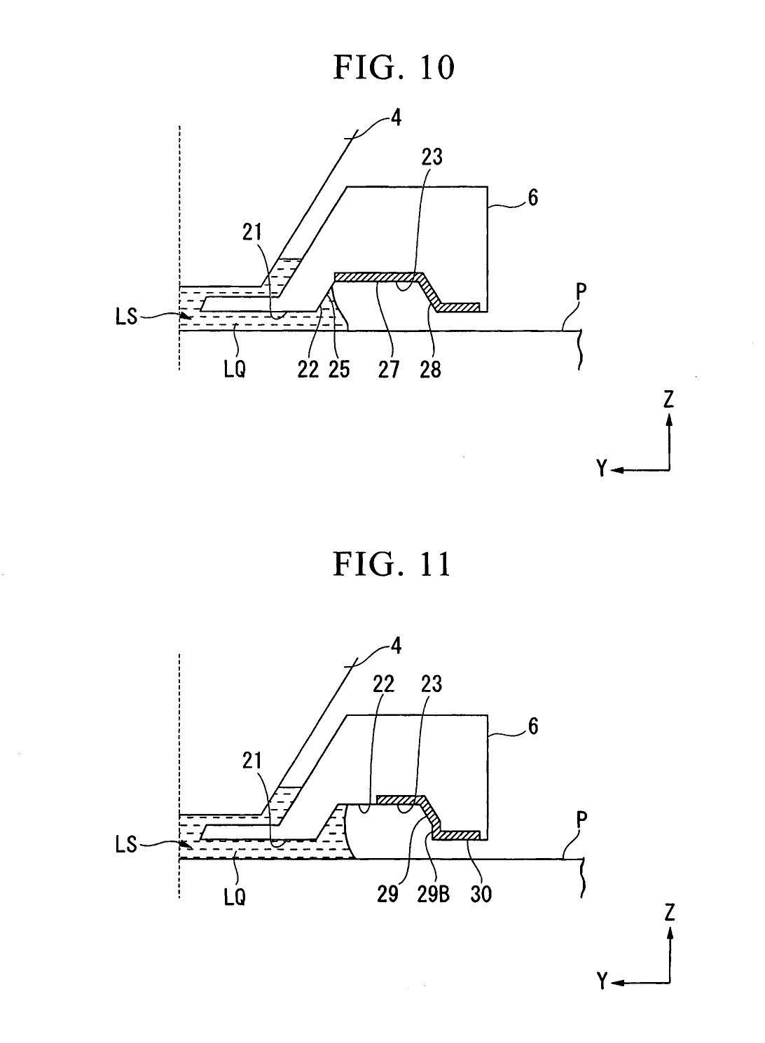

In addition, in the present embodiment discussed above, the second surface 22 comprises the second area 26, which is substantially parallel to the first surface 21, but the second area does not have to be disposed, as shown in FIG. 10. In the example shown in FIG. 10, the third area 27 of the liquid recovery surface 23 is disposed so that it adjoins the outer edges of the first area 25 of the second surface 22, which is inclined with respect to the first surface 21. In the example shown in FIG. 10 as well, it is possible to increase the weight of the liquid LQ of the immersion space LS and to thereby prevent the liquid LQ from leaking, remaining behind, and the like.

In addition, as shown in FIG. 11, a perpendicular area 29B that is perpendicular to the first surface 21 may be disposed in the liquid recovery surface 23 between the inclined area 29 of the fourth area 28 and the parallel area 30. In the example shown in FIG. 11 as well, it is possible to increase the weight of the liquid LQ of the immersion space LS and thereby to prevent the liquid LQ from leaking, remaining behind, and the like.

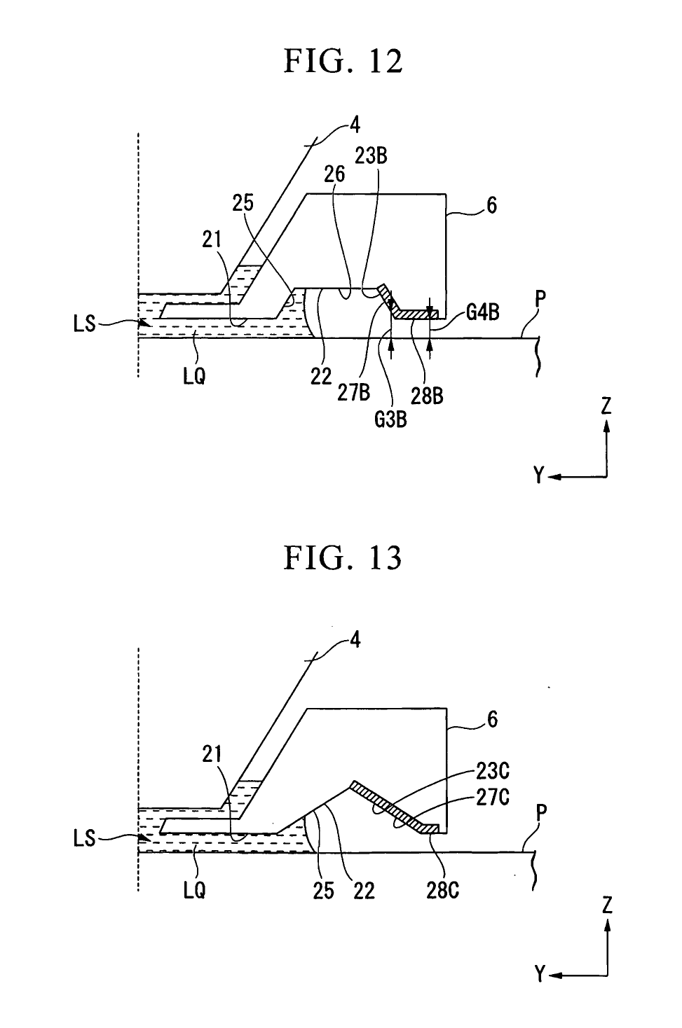

In addition, as shown in FIG. 12, a third area 27B of a liquid recovery surface 23B, which is disposed adjacent to the second surface 22 (the second area 26) may be inclined with respect to the first surface 21. In FIG. 12, the third area 27B is inclined so that it gradually approaches the front surface of the substrate P in the directions that lead away from the optical path of the exposure light EL (in the radial directions with respect to the optical axis AX). In another example, the fourth area 28B can be non-parallel to the first surface 21. In addition, in the example shown in FIG. 12, a fourth area 28B is disposed so that it adjoins the outer edges of the third area 27B and is substantially parallel to the first surface 21. In the example shown in FIG. 12 as well, a spacing G4B between the fourth area 28B and the front surface of the substrate P is smaller than a spacing G3B between the third area 27B and the front surface of the substrate P. In the example shown in FIG. 12 as well, it is possible to increase the weight of the liquid LQ of the immersion space LS and thereby to prevent the liquid LQ from leaking, remaining behind, and the like.

In addition, as shown in FIG. 13, the second area 26 of the second surface 22 may be eliminated and a third area 27C of a liquid recovery surface 23C, which is inclined with respect to the first surface 21, may be disposed so that it adjoins the outer edges of the first area 25 of the second surface 22, which is inclined with respect to the first surface 21. In addition, in the example shown in FIG. 13, a fourth area 28C is disposed so that it adjoins the outer edges of the third area 27C and is substantially parallel to the first surface 21. In another example, the fourth area 28B can be non-parallel to the first surface 21. In the example shown in FIG. 13 as well, it is possible to increase the weight of the liquid LQ of the immersion space LS and thereby to prevent the liquid LQ from leaking, remaining behind, and the like.

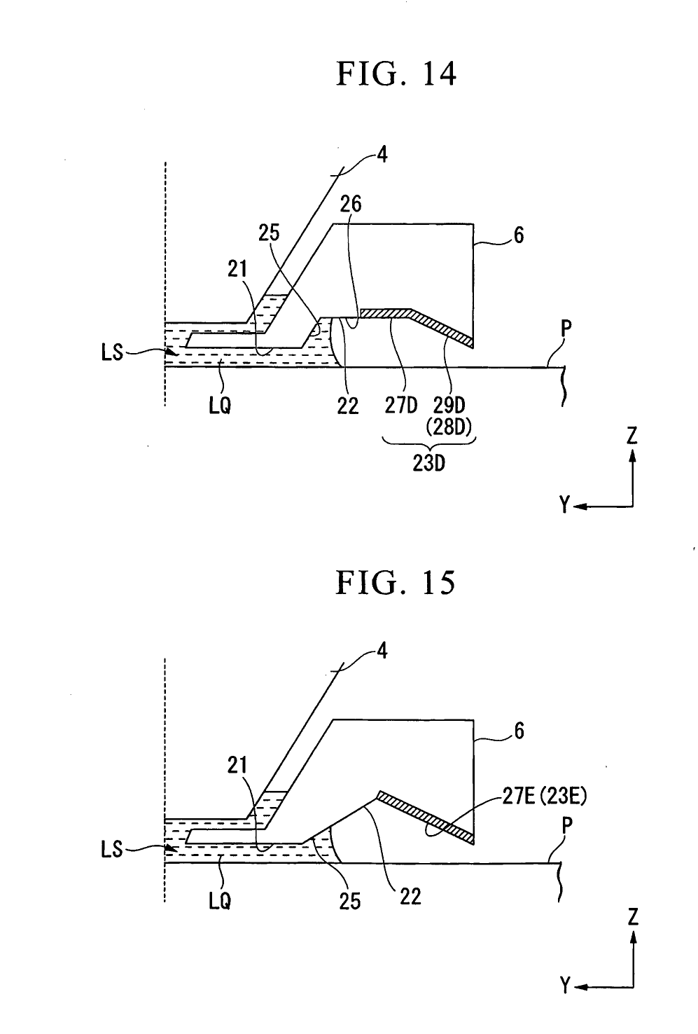

In addition, as shown in FIG. 14 and FIG. 15, at least part of the fourth area 28 of the liquid recovery surface 23 may be eliminated. In the example shown in FIG. 14, a liquid recovery surface 23D comprises a third area 27D, which is substantially parallel to the first surface 21, and a fourth area 28D (an inclined area 29D), which is inclined with respect to the first surface 21 and is not provided with a parallel area. In addition, in the example shown in FIG. 15, a liquid recovery surface 23E has only a third area 27E, which is inclined with respect to the first surface 21, and does not have a fourth area. In the example shown in FIG. 14 and FIG. 15, it is possible to increase the weight of the liquid LQ of the immersion space LS.

### Second Embodiment

The following explains a second embodiment. In the explanation below, constituent parts that are identical or equivalent to those in the embodiment discussed above are assigned identical symbols, and the explanations thereof are therefore abbreviated or omitted.

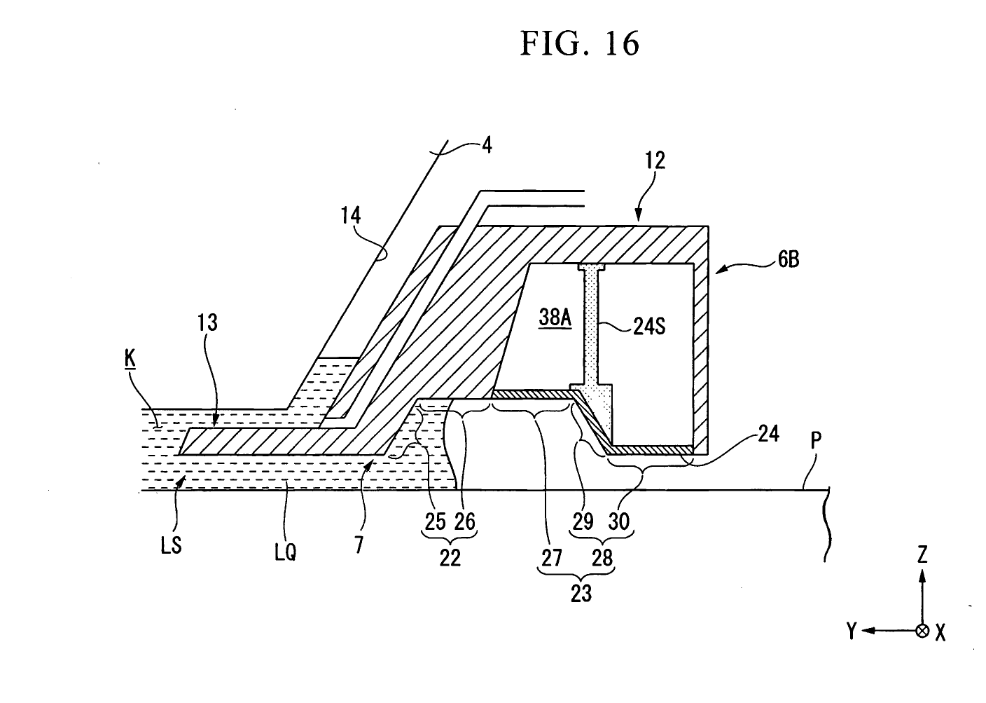

FIG. 16 shows a liquid immersion member 6B according to the second embodiment. The characteristic portion of the liquid immersion member 6B according to the second embodiment differs from that of the first embodiment discussed above in that support members 24S are provided that support the porous member 24.

Similar to the first embodiment discussed above, the porous member 24 is a plate shaped member. The support members 24S function as reinforcing members that reinforce the porous member 24. The support members 24S are disposed in the interior of the recovery passageway 38A, and contact at least part of the upper surface of the porous member 24. One part of each of the support members 24S is connected to at least part of an inner wall surface of the side plate part 12 that forms the recovery passageway 38A, and another part of each is connected to at least part of the upper surface of the porous member 24.

In the present embodiment, an upper end of each of the support members 24S is connected to part of the inner wall surface of the side plate part 12 that faces the −Z direction (the part of the inner wall surface of the side plate part 12 that opposes the porous member 24), and a lower end of each of the support members 24S is connected to at least part of the upper surface of the porous member 24 in the inclined area 29. Furthermore, the lower end of each of the support members 24S may be connected to at least part of the upper surface of the porous member 24 in the third area 27, or at least part of the upper surface of the porous member 24 in the parallel area 30.

Each of the support members 24S is a member wherein numerous, minute pores are formed. In the present embodiment, each of the support members 24S is made of a ceramic (porous ceramic) material wherein numerous pores are formed. Furthermore, a sintered member (e.g., sintered metal), a foam member (e.g., metal foam), or the like, wherein numerous pores are formed, may be used for each of the support members 24S.

In the present embodiment, the support members 24S are rod shaped members and a plurality thereof is disposed around the optical path space K. Furthermore, the support members 24S may be formed annularly within the XY plane and their lower ends may be connected to substantially the entire upper surface of the porous member 24 in the inclined area 29.

Disposing the support members 24S according to the present embodiment as explained above makes it possible to reinforce the porous member 24. Accordingly, even if the porous member 24 has a bent portion as in the present embodiment, it is possible to reinforce the porous member 24 with the support members 24S and thereby to maintain the shape and the strength of the porous member 24.

In addition, the support members 24S according to the present embodiment are members wherein numerous pores are formed, which makes it possible to perform the liquid recovery operation smoothly using the liquid recovery surface 23 and the recovery passageway 38A. For example, even if the lower end of each of the support members 24S is connected to the upper surface of the porous member 24 in the inclined area 29, the liquid immersion member 6B can recover at least part of the liquid LQ on the substrate P that opposes the liquid recovery surface 23 over substantially the entire liquid recovery surface 23, including the inclined area 29. In addition, the support members 24S are members wherein numerous pores are formed, and therefore the liquid LQ moves smoothly between the spaces of the recovery passageway 38A that are on the inner side and the outer side of each of the support members 24S with respect to the optical path space K.

### Third Embodiment

The following explains a third embodiment. In the explanation below, constituent parts that are identical or equivalent to those in the embodiment discussed above are assigned identical symbols, and the explanations thereof are therefore abbreviated or omitted.

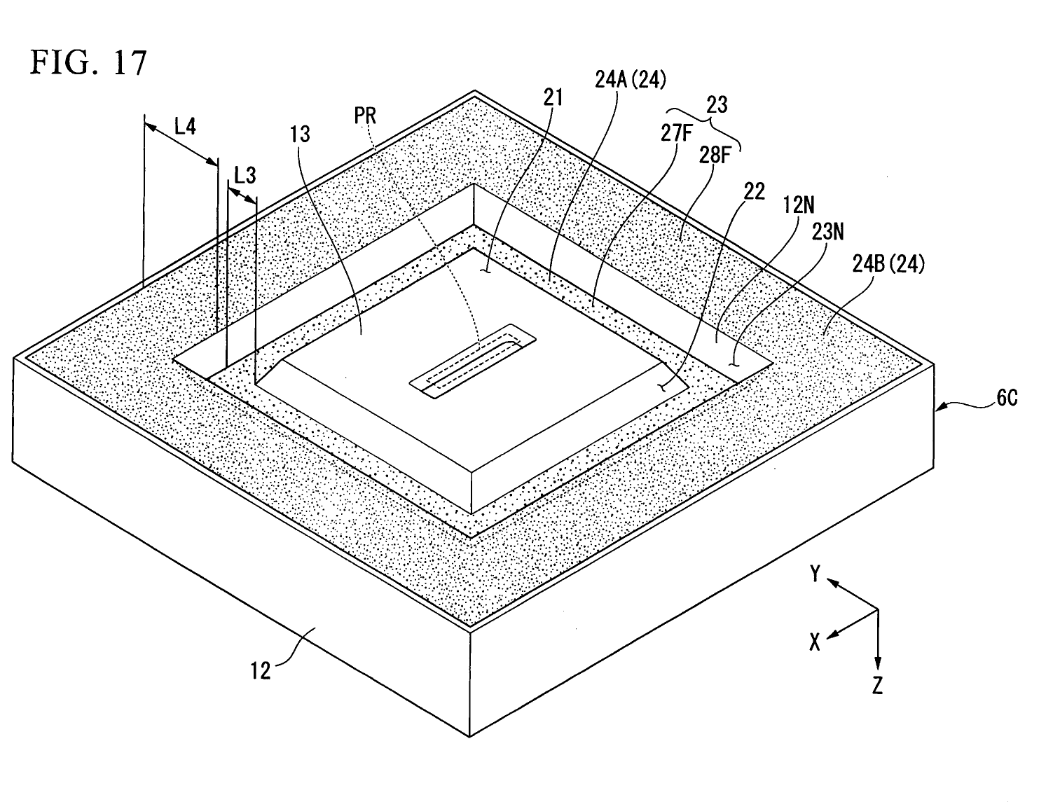

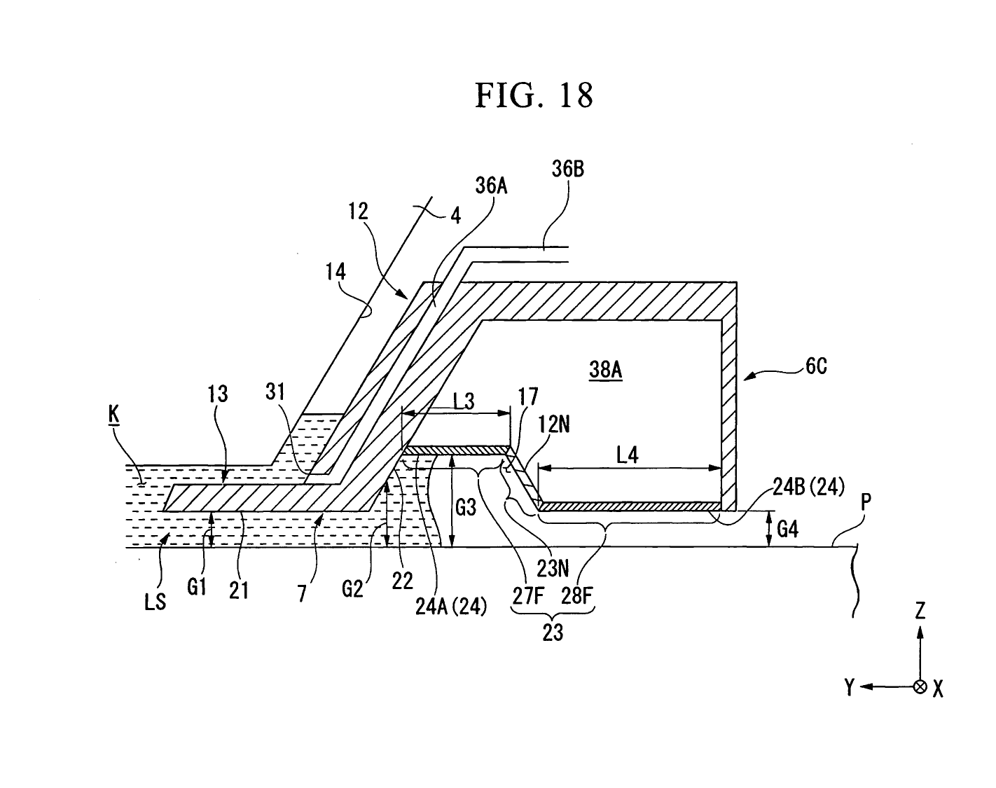

FIG. 17 is an oblique view that shows a liquid immersion member 6C according to the third embodiment, viewed from the lower side, and FIG. 18 is a partial, enlarged, side cross sectional view of the liquid immersion member 6C. In FIG. 17 and FIG. 18, the liquid immersion member 6C comprises the first surface 21, which is disposed around the optical path of the exposure light EL, the second surface 22, which is provided so that it adjoins the outer edges of the first surface 21, and the liquid recovery surface 23, which is provided on the outer sides of the second surface 22 with respect to the optical path of the exposure light EL. Similar to the embodiments discussed above, the liquid recovery surface 23 includes the lower surface of the porous member 24.

The liquid recovery surface 23 includes a third area 27F, which is disposed so that it is adjacent to the outer edges of the second surface 22, and a fourth area 28F, which is disposed at the outer sides of the third area 27F with respect to the optical path of the exposure light EL. In the present embodiment, the third area 27F and the fourth area 28F are substantially parallel. In the present embodiment, the third area 27F and the fourth area 28F are each substantially parallel to the front surface of the substrate P (the XY plane). In addition, similar to the embodiments discussed above, the first surface 21 is substantially parallel to the front surface of the substrate P (the XY plane). Namely, in the present embodiment, the fourth area 28F is substantially parallel to the first surface 21. In another example, at least one of the third area 27F and the fourth area 28F can be substantially non-parallel to the first surface 21.

In addition, in the present embodiment, the second surface 22 is inclined with respect to the first surface 21. The second surface 22 is inclined so that it becomes gradually spaced apart from the front surface of the substrate P in the directions that lead away from the optical path of the exposure light EL. Namely, the second surface 22 is inclined so that it becomes gradually spaced apart from the front surface of the substrate P in the radial directions with respect to the optical axis AX of the projection optical system PL.

In the present embodiment, a non-recovery area 23N that is incapable of recovering the liquid LQ and is inclined with respect to the third area 27F is disposed between the third area 27F and the fourth area 28F in the radial directions with respect to the optical path of the exposure light EL (the optical axis AX of the projection optical system PL). The non-recovery area 23N includes a surface (the lower surface) of a plate member 12N, which is made of a metal such as titanium. In addition, in the present embodiment, the third area 27F includes a lower surface of a first porous member 24A, and the fourth area 28F includes a lower surface of a second porous member 24B. Namely, in the present embodiment, the liquid immersion member 6C comprises: the side plate part 12; the lower plate part 13 that forms the first surface 21; the first porous member 24A that forms the third area 27F; the plate member 12N that forms the non-recovery area 23N; and the second porous member 24B that forms the fourth area 28F. Furthermore, in the present embodiment, the side plate part 12, the lower plate part 13, and the plate member 12N are formed from the same material (e.g., titanium), but they may be formed from different materials.

In the present embodiment, when the substrate P is disposed at a position at which it opposes the first surface 21, the second surface 22, and the liquid recovery surface 23, the spacing G2 between the second surface 22 and the front surface of the substrate P is larger than the spacing G1 between the first surface 21 and the front surface of the substrate P in the Z axial directions, the spacing G3 between the third area 27F and the front surface of the substrate P is larger than the spacing G1 between the first surface 21 and the front surface of the substrate P in the Z axial directions, and the spacing G4 between the fourth area 28F and the front surface of the substrate P is smaller than the spacing G3 between the third area 27F and the front surface of the substrate P in the Z axial directions.

In addition, in the present embodiment, the spacing G4 between the fourth area 28F and the front surface of the substrate P and the spacing G1 between the first surface 21 and the front surface of the substrate P are substantially equal in the Z axial directions. Namely, in the present embodiment, the first surface 21 and the fourth area 28F are disposed substantially in the same plane (they are substantially flush). Furthermore, the spacing G1 and the spacing G4 may be different.

In the present embodiment, a size L4 (radial length) of the fourth area 28F is greater than a size L3 (radial length) of the third area 27F in the radial directions with respect to optical path of the exposure light EL (the optical axis AX of the projection optical system PL). In the embodiment, the area of the fourth area 28F can be greater than the area of the third area 27F. In another embodiment, in the radial direction, the size L4 (radial length) of the fourth area 28F can be substantially equal to the size L3 (radial length) of the third area 27F. Since the fourth area 28F is disposed radially outside the third area 27F, the area of the fourth area 28F can be greater than the area of the third area 27F when L4 and L3 are substantially the same.

Similar to the embodiments discussed above, the liquid recovery surface 23 recovers at least part of the liquid LQ on the substrate P, which opposes the liquid recovery surface 23, by suctioning it. In the present embodiment, the suction force at the fourth area 28F and the suction force at the third area 27F are different. The suction force includes the quantity of liquid recovered (amount of the liquid LQ that can be recovered) at each of the third and fourth areas 27F, 28F per unit of area and per unit of time. In the present embodiment, the suction force at the fourth area 28F is greater than the suction force at the third area 27F. Namely, in the present embodiment, the quantity of liquid recovered (the recovery capacity) per unit of area and per unit of time at the fourth area 28F is greater than that of the third area 27F.

In the present embodiment, the pores that are formed in the first and second porous members 24A, 24B pass through, substantially parallel to the Z axis, the space between the lower surfaces, which oppose the substrate P, and the upper surfaces, which contact the recovery passageway 38A, of the first and second porous members 24A, 24B; furthermore, the percentage of the total area of the pores (i.e., the total area of the pores per unit area) at the fourth area 28F (the lower surface of the second porous member 24B) differs from the percentage of the total area of the pores (i.e., the total area of the pores per unit area) at the third area 27F (the lower surface of the first porous member 24A). Namely, the aperture percentage (i.e., the aperture area per unit area) in the fourth area 28F differs from the aperture percentage (i.e., the aperture area per unit area) in the third area 27F. Or, the void fraction at the fourth area 28F differs from the void fraction at the third area 27F.

For example, creating a difference between the sizes (the diameters) of the pores that are formed in the first porous member 24A and the sizes (the diameters) of the pores that are formed in the second porous member 24B makes it possible to create a difference in the percentage of the total area of the pores in the third area 27F and the percentage of the total area of the pores in the fourth area 28F. In the present embodiment, the sizes of the pores that are formed in the second porous member 24B are greater than the sizes of the pores that are formed in the first porous member 24A. The suction force at the fourth area 28F is also greater than the suction force at the third area 27F.

In addition, even if the diameters of the pores that are formed in the first and second porous members 24A, 24B are the same, it is possible to create a difference between the percentage of the total area of the pores (i.e., the total area of the pores per unit area) in the third area 27F and the percentage of the total area of the pores (i.e., the total area of the pores per unit area) in the fourth area 28F by creating a difference between the number of pores per unit of area that are formed in the first porous member 24A and the number of pores per unit of area that are formed in the second porous member 24B. Namely, creating a difference between the density of the pores in the third area 27F and the density of the pores in the fourth area 28F makes it possible to create a difference between the percentage of the total area of the pores in the third area 27F and the percentage of the total area of the pores in the fourth area 28F. Accordingly, in the present embodiment, the density of the pores in the third area 27F may be made greater than the density of the pores in the fourth area 28F. In so doing, it is possible to make the suction force at the fourth area 28F greater than the suction force at the third area 27F.

As explained above, according to the present embodiment, the size L4 of the fourth area 28F is made greater than the size L3 of the third area 27F in the radial directions with respect to the optical path of the exposure light EL; therefore, as was explained referencing FIG. 8 for example, even if the liquid LQ on the substrate P between the liquid immersion member 6C and the substrate P forms a film (or a drop), that liquid LQ can be recovered more reliably at the fourth area 28F of the liquid recovery surface 23. Namely, because the size L4 of the fourth area 28F is large, the liquid LQ (a film, a drop, or the like) on the substrate P, which opposes the liquid recovery surface 23, can contact the fourth area 28F more reliably. Accordingly, the liquid LQ can be recovered more reliably at the fourth area 28F.

In addition, according to the present embodiment, the suction force at the third area 27F is less than the suction force at the fourth area 28F, which prevents the liquid LQ between the third area 27F and the substrate P from forming a thin film. In addition, even if a thin film of the liquid LQ is formed between the third area 27F and the substrate P, the liquid LQ on the substrate P, which opposes the fourth area 28F, can be recovered more reliably because the fourth area 28F, which has a suction force that is greater than that of the third area 27F, is disposed closer to the substrate P than the third area 27F is. Accordingly, it is possible to prevent a drop or the like of the liquid LQ from remaining on the substrate P.

Furthermore, the suction force at the third area 27F may be made greater than the suction force at the fourth area 28F. For example, the suction force at the third area 27F may be set greater than the suction force at the fourth area 28F under conditions wherein a thin film of the liquid LQ does not tend to be formed, e.g., if the distance of travel of the substrate P is short or if the movement speed of the substrate P is not very fast. In such a case as well, the portion of the liquid LQ that was not fully recovered by the third area 27F can be recovered by the fourth area 28F.

In addition, the present embodiment explained a case wherein the size L4 of the fourth area 28F is greater than the size L3 of the third area 27F with respect to the liquid immersion member 6C; however, the size L4 does not have to be larger than the size L3 over the entire area surrounding the third area 27F. In addition, the size L4 of the fourth area 28F may be made smaller than the size L3 of the third area 27F, or the size L3 and the size L4 may be made substantially the same size.

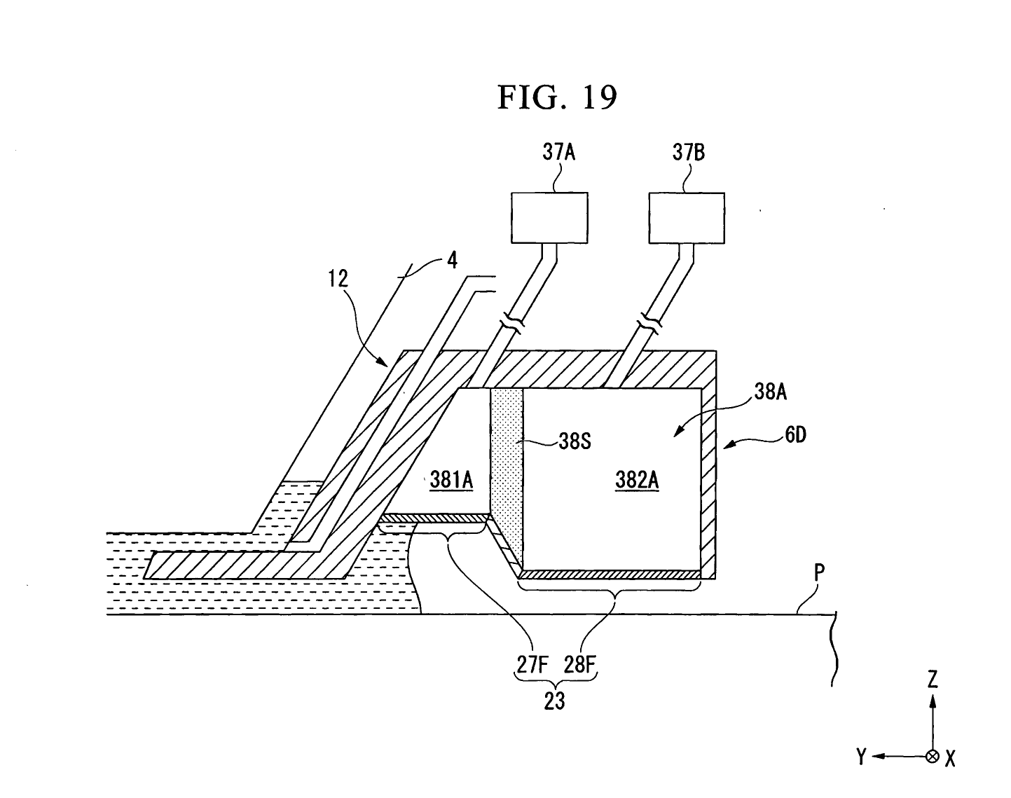

Furthermore, in order to create a difference between the suction forces at the third area 27F and the fourth area 28F, a partition member 38S may divide the recovery passageway 38A into a recovery passageway 381A, which recovers the liquid LQ via the third area 27F, and a recovery passageway 382A, which recovers the liquid LQ via the fourth area 28F, as in a liquid immersion member 6D shown in FIG. 19 for example; thereby, a difference is created in the suction force that is applied to the recovery passageway 381A by a liquid recovery apparatus 37A and the suction force that is applied to the recovery passageway 382A by a liquid recovery apparatus 37B. Namely, a difference may be created between the suction force at the third area 27F and the suction force at the fourth area 28F by making the pressure differential between the lower surface, which opposes the substrate P, and the upper surface, which contacts the recovery passageway 381A, of the first porous member 24A different than the pressure differential between the lower surface, which opposes the substrate P, and the upper surface, which contacts the recovery passageway 382A, of the second porous member 24B.

Furthermore, in the third embodiment, a plurality of above-described methods can be appropriately combined with each other so that the suction force at the third area 27F differs from the suction force at the fourth area 28F.

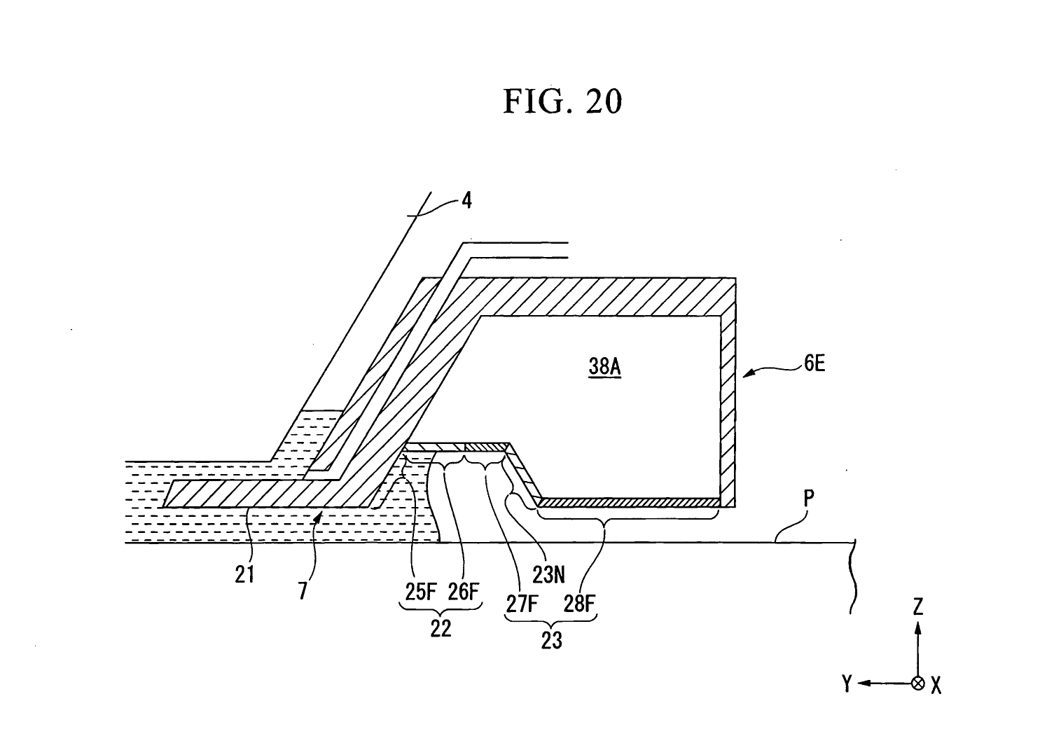

Furthermore, in the third embodiment discussed above, the second surface 22 may comprise a first area 25F, which is provided so that it adjoins the outer edges of the first surface 21, that is inclined with respect to the first surface 21 and a second area 26F, which is provided so that it adjoins the outer edges of the first area 25F, that is substantially parallel to the first surface 21, as in a liquid immersion member 6E shown in FIG. 20 for example.

In addition, in the third embodiment discussed above, the non-recovery area 23N is provided between the third area 27F and the fourth area 28F; however, there may be a liquid recovery area between the third area 27F and the fourth area 28F, as in the first embodiment discussed above. In this case, the suction force of the liquid recovery area between the third area 27F and the fourth area 28F may be set to a suction force that is between the suction force of the third area 27F and the suction force of the fourth area 28F. For example, the suction force of the liquid recovery area between the third area 27F and the fourth area 28F may be set greater than the suction force of the third area 27F and less than the suction force of the fourth area 28F. Namely, the suction force of the third area 27F, the suction force of the liquid recovery area between the third area 27F and the fourth area 28F, and the suction force of the fourth area 28F may be varied in steps. In addition, the suction force of the third area 27F, the suction force of the liquid recovery area between the third area 27F and the fourth area 28F, and the suction force of the fourth area 28F may be varied gradually (continuously) in the radial directions with respect to the optical path of the exposure light EL.

In each of the embodiments discussed above, the term of “annular” can include a substantially rectangular shaped annular. Alternatively or also, “annular” can include various shapes such as a substantially rectangular shaped annular, a substantially ring shaped annular, a substantially circular shaped annular, a substantially polygon shaped annular, and the like. Furthermore, “annular” can not be limited in a closed form substantially continuing in a circumferential direction, and can include an intermittent form.

In each of the embodiments discussed above, the term of “an inclined area” or “an area with respect to someone” can include a plane surface or a flat region, which has a constant gradient with respect to the above-described reference surface (XY plane). Alternatively or also, the term of “an inclined area” or “an area with respect to someone” can include a region, which has a gradually changing gradient with respect to the reference surface, such as curved region, or a region, which has a stepped gradient, such as a bend region.

Furthermore, with the projection optical system PL in each of the embodiments discussed above, the optical path space K on the emergent side (the image plane side) of the last optical element 4 is filled with the liquid LQ, but it is also possible to adopt a projection optical system wherein the optical path space K on the incident side (the object plane side) of the last optical element 4 is also filled with the liquid LQ, as disclosed in PCT International Publication WO2004/019128.

Furthermore, although the liquid LQ in the embodiments discussed above is water, it may be a liquid other than water. It is preferable to use a liquid that is transparent to the exposure light EL, has as high a refractive index as possible, and is stable with respect to the projection optical system PL or the film of the photosensitive material (the photoresist) that forms the front surface of the substrate P as the liquid LQ. It is also possible to use hydro-fluoro-ether (HFE), perfluorinated polyether (PFPE), Fomblin oil, cedar oil, or the like as the liquid LQ. In addition, a liquid that has a refractive index of approximately 1.6 to 1.8 may be used as the liquid LQ. Furthermore, the optical element (the last optical element 4 or the like) of the projection optical system PL that contacts the liquid LQ may be may for example be formed from quartz (silica), or from fluorite, barium fluoride, strontium fluoride, lithium fluoride, sodium fluoride, or single-crystal materials of other fluoride compounds. Furthermore, the terminus optical element may be formed from materials with a refractive index higher than that of quartz or fluorite (for example 1.6 or higher). Furthermore, a thin film having liquid affinity properties and/or a dissolution-preventing function may be formed on a portion of (including at least the contact faces with the liquid) or the entirety of the terminus optical element. In addition, it is also possible to use various fluids, e.g., a supercritical fluid, as the liquid LQ. Also, as the liquid, it is preferable that a liquid be used which has a low optical absorption coefficient, a small temperature dependence, and which is stable with respect to photosensitive materials (or topcoat films, or anti-reflection films, or similar) applied to the surfaces of the projection optical system and/or substrate.

In addition, if, for example, F₂ laser light, which does not transmit through water, is used as the exposure light EL, then a fluid that can transmit the F₂ laser light can be used as the liquid LQ, e.g., a fluorine based fluid such as perfluoropolyether (PFPE) or a fluorine based oil. In this case, portions that contact the liquid LQ are lyophilically treated by forming a thin film with, for example, a substance that has a molecular structure that contains fluorine or the like and has low polarity.

Furthermore, the substrate P in each of the embodiments discussed above is not limited to a semiconductor wafer for fabricating semiconductor devices, but can also be adapted to, for example, a glass substrate for display devices, a ceramic wafer for thin film magnetic heads, or the original plate of a mask or a reticle (synthetic quartz or a silicon wafer), film member, and similar that is used by an exposure apparatus. Moreover, substrates are not limited to round shape, but may be rectangular or other shapes.

The exposure apparatus EX can also be adapted to a step-and-scan type scanning exposure apparatus (a scanning stepper) that scans and exposes the pattern of the mask M by synchronously moving the mask M and the substrate P, as well as to a step-and-repeat type projection exposure apparatus (a stepper) that performs full field exposure of the pattern of the mask M with the mask M and the substrate P in a stationary state, and sequentially steps the substrate P.

Furthermore, when performing an exposure with a step-and-repeat system, the projection optical system PL is used to transfer a reduced image of a first pattern onto the substrate P in a state wherein the first pattern and the substrate P are substantially stationary, after which the projection optical system PL may be used to perform full-field exposure of the substrate P, wherein a reduced image of a second pattern partially superposes the transferred first pattern in a state wherein the second pattern and the substrate P are substantially stationary (as in a stitching type full-field exposure apparatus). In addition, the stitching type exposure apparatus can also be adapted to a step-and-stitch type exposure apparatus that transfers at least two patterns onto the substrate P so that they are partially superposed, and sequentially steps the substrate P.

In addition, the present invention can also be adapted to, for example, an exposure apparatus that combines the patterns of two masks on a substrate through a projection optical system and double exposes, substantially simultaneously, a single shot region on the substrate using a single scanning exposure, as disclosed in, for example, U.S. Pat. No. 6,611,316. In addition, the present invention can also be adapted to, for example, a proximity type exposure apparatus and a mirror projection aligner.

In addition, the present invention can also be adapted to a twin stage type exposure apparatus that is provided with a plurality of substrate stages, as disclosed in, for example, U.S. Pat. No. 6,341,007, U.S. Pat. No. 6,400,441, U.S. Pat. No. 6,549,269, U.S. Pat. No. 6,590,634, U.S. Pat. No. 6,208,407, and U.S. Pat. No. 6,262,796. In this case, each of the substrate stages can be as an object, which is capable of opposing the emergent surface 5 of the last optical element 4 and is also capable of opposing the lower surface 7 of the liquid immersion member 6.

Furthermore, as disclosed in, for example, Japanese Patent Application Publication No. H11-135400A and U.S. Pat. No. 6,897,963, the exposure apparatus EX can also be adapted to an exposure apparatus that is provided with a substrate stage that holds the substrate, and a measurement stage whereon a fiducial member (wherein a fiducial mark is formed) and/or various photoelectric sensors are mounted. In addition, the present invention can also be adapted to an exposure apparatus that comprises a plurality of substrate stages and measurement stages. Disposing the measurement stage at a position at which it opposes an emergent surface of the last optical element and a lower surface of the liquid immersion member makes it possible to form the immersion space between the measurement stage on one side and the last optical element and the liquid immersion member on the other side.

The type of exposure apparatus EX is not limited to a semiconductor device fabrication exposure apparatus that exposes the substrate P with the pattern of a semiconductor device, but can also be widely adapted to exposure apparatuses that are used for fabricating, for example, liquid crystal devices or displays, and to exposure apparatuses that are used for fabricating thin film magnetic heads, image capturing devices (CCDs), micromachines, MEMS devices, DNA chips, or reticles and masks.

Furthermore, in each of the embodiments discussed above, the positional information of the mask stage 1 and the substrate stage 2 is measured using an interferometer system that comprises the laser interferometers 1S, 2S, but the present invention is not limited thereto; for example, an encoder system may be used that detects a scale (diffraction grating) that is provided to each of the stages 1, 2. In this case, the system is preferably configured as a hybrid system that is provided with both an interferometer system and an encoder system, and it is preferable to use the measurement results of the interferometer system to calibrate the measurement results of the encoder system. In addition, the position of the stages may be controlled by switching between the interferometer system and the encoder system, or by using both.

In addition, in each of the embodiments discussed above, an ArF excimer laser may be used as a light source apparatus that generates ArF excimer laser light, which serves as the exposure light EL; however, as disclosed in, for example, U.S. Pat. No. 7,023,610, a harmonic generation apparatus may be used that outputs pulsed light with a wavelength of 193 nm and that comprises: an optical amplifier part, which has a solid state laser light source (such as a DFB semiconductor laser or a fiber laser), a fiber amplifier, and the like; and a wavelength converting part. Furthermore, in the above mentioned embodiments, both the illumination area and the projection area are rectangular, but they may be some other shape, e.g., arcuate.

Furthermore, in each of the embodiments discussed above, a light transmitting type mask is used wherein a prescribed shielding pattern (or a phase pattern or a dimming pattern) is formed on a light transmitting substrate; however, instead of such a mask, a variable forming mask (also called an electronic mask, an active mask, or an image generator), wherein a transmittance pattern, a reflected pattern, or a light emitting pattern is formed based on electronic data of the pattern to be exposed, may be used as disclosed in, for example, U.S. Pat. No. 6,778,257. The variable forming mask comprises a digital micromirror device (DMD), which is one kind of non-emissive type image display device (also called a Spatial Light Modulator (SLM)). The exposure apparatus using a DMD is disclosed for example in U.S. Pat. No. 6,778,257. In addition, the variable forming mask is not limited to a DMD, and a non-emissive type image display device, which is explained below, may be used instead. Here, the non-emissive type image display device is a device that spatially modulates the amplitude (the intensity), the phase, or the polarization state of the light that travels in a prescribed direction; furthermore, examples of a transmissive type spatial light modulator include a transmissive type liquid crystal display (LCD) as well as an electrochromic display (ECD). In addition, examples of a reflecting type spatial light modulator include a DMD, which was discussed above, as well as a reflecting mirror array, a reflecting type LCD, an electrophoretic display (EPD), electronic paper (or electronic ink), and a grating light valve.

In addition, instead of a variable forming mask that is provided with a non-emissive type image display device, a pattern forming apparatus that comprises a self luminous type image display device may be provided. In this case, an illumination system is not necessary. Here, examples of a self luminous type image display device include a cathode ray tube (CRT), an inorganic electroluminescence display, an organic electroluminescence display (OLED: organic light emitting diode), an LED display, an LD display, a field emission display (FED), and a plasma display (PDP: plasma display panel). In addition, a solid state light source chip that has a plurality of light emitting points or that creates a plurality of light emitting points on a single substrate, a solid state light source chip array wherein a plurality of chips are arrayed, or the like may be used as the self luminous type image display device that constitutes the pattern forming apparatus, and the pattern may be formed by electrically controlling the solid state light source chip(s). Furthermore, it does not matter whether the solid state light source device is inorganic or organic.

Each of the embodiments discussed above explained an exemplary case of an exposure apparatus that is provided with the projection optical system PL, but the present invention can be adapted to an exposure apparatus and an exposing method that do not use the projection optical system PL. Thus, even if the projection optical system PL is not used, the exposure light is radiated onto the substrate through optical members, e.g., lenses, and an immersion space is formed in a prescribed space between the substrate and those optical members.

In addition, by forming interference fringes on the substrate P as disclosed in, for example, PCT International Publication WO2001/035168, the present invention can also be adapted to an exposure apparatus (a lithographic system) that exposes the substrate P with a line-and-space pattern.

Furthermore, the requirements of each of the embodiments discussed above can be appropriately combined. As far as is permitted, each disclosure of every published document and U.S. patent related to the exposure apparatus recited in each of the embodiments discussed above, modified examples, and the like is hereby incorporated by reference.

As described above, the exposure apparatus EX of the embodiments is manufactured by assembling various subsystems, including each constituent element, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus EX from the various subsystems includes, for example, the mechanical interconnection of the various subsystems, the wiring and connection of electrical circuits, and the piping and connection of the atmospheric pressure circuit. Naturally, prior to performing the process of assembling the exposure apparatus EX from these various subsystems, there are also the processes of assembling each individual subsystem. When the process of assembling the exposure apparatus EX from the various subsystems is complete, a comprehensive adjustment is performed to ensure the various accuracies of the exposure apparatus EX as a whole. Furthermore, it is preferable to manufacture the exposure apparatus EX in a clean room wherein, for example, the temperature and the cleanliness level are controlled.

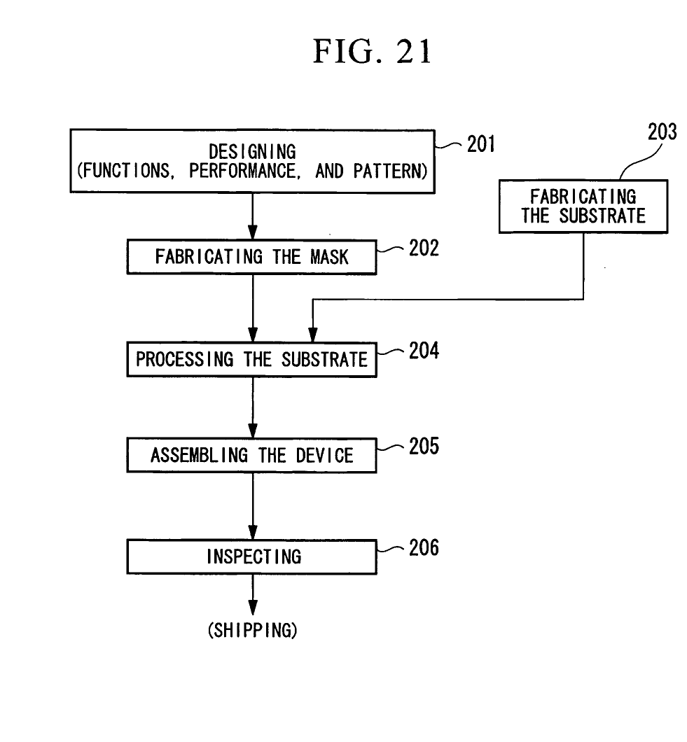

As shown in FIG. 21, a micro-device, such as a semiconductor device, is manufactured by: a step 201 that designs the functions and performance of the micro-device; a step 202 that fabricates a mask (a reticle) based on this designing step; a step 203 that fabricates a substrate, which is the base material of the device; a substrate processing step 204 that comprises a substrate process (exposure process) that includes, in accordance with the embodiments discussed above, exposing the substrate with the exposure light using the mask pattern and developing the exposed substrate; a device assembling step 205 (which includes fabrication processes such as dicing, bonding, and packaging processes); an inspecting step 206; and the like.

1. An exposure apparatus that exposes a substrate with exposure light through a liquid, comprising:
a first surface, which is disposed around an optical path of the exposure light;
a second surface, which is disposed adjacent to an outer edge of the first surface, the second surface comprising a first area, which is inclined with respect to the first surface; and
a liquid recovery surface, which is disposed at an outer side of the second surface with respect to the optical path of the exposure light;
wherein,
when an object is disposed at a position at which the object opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object.

2. An exposure apparatus according to claim 1, wherein the first surface is substantially parallel to the front surface of the object.

3. An exposure apparatus according to claim 1, wherein
the second surface is disposed around the first surface.

4. An exposure apparatus according to claim 1, wherein
the first area is disposed adjacent to the outer edge of the first surface.

5. An exposure apparatus according to claim 4, wherein
the second surface comprises a second area, which is disposed adjacent to an outer edge of the first area, that is substantially parallel to the first surface.

6. An exposure apparatus according to claim 1, wherein
the first area becomes gradually spaced apart from the front surface of the object along a direction leading away from the optical path.

7. An exposure apparatus according to claim 1, wherein
the second surface is provided so that the second surface maintains contact with the liquid that is present between the second surface and the front surface of the object.

8. An exposure apparatus according to claim 1, wherein
the liquid recovery surface is disposed around the optical path.

9. An exposure apparatus according to claim 1, wherein
the liquid recovery surface comprises a third area, which is disposed adjacent to an outer edge of the second surface.

10. An exposure apparatus according to claim 9, wherein
the third area is inclined with respect to the first surface.

11. An exposure apparatus according to claim 10, wherein
the third area gradually approaches the front surface of the object along a direction leading away from the optical path.

12. An exposure apparatus according to claim 9, wherein
the third area is substantially parallel to the first surface.

13. An exposure apparatus according to claim 9, wherein
the liquid recovery surface comprises a fourth area, which is disposed at an outer side of the third area; and
the spacing between the fourth area and the object is smaller than the spacing between the third area and the object in the prescribed direction.

14. An exposure apparatus according to claim 13, wherein
at least a part of the fourth area is inclined with respect to the third area.

15. An exposure apparatus according to claim 14, wherein
at least a part of the fourth area gradually approaches the front surface of the object along a direction leading away from the optical path.

16. An exposure apparatus according to claim 13, wherein
at least a part of the fourth area is substantially parallel to the first surface.

17. An exposure apparatus according to claim 16, wherein
the spacing between at least a part of the fourth area and the object is equivalent to or substantially equal to the spacing between the first surface and the object in the prescribed direction.

18. An exposure apparatus according to claim 13, wherein
the fourth area is disposed adjacent to the outer edge of the third area.

19. An exposure apparatus according to claim 1, wherein
the first surface is lyophilic with respect to the liquid.

20. An exposure apparatus according to claim 1, wherein
the second surface is lyophilic with respect to the liquid.

21. An exposure apparatus according to claim 1, wherein
the liquid recovery surface comprises a front surface of a porous member; and
at least part of the liquid on the object, which opposes the liquid recovery surface, is recovered via the porous member.

22. An exposure apparatus according to claim 1, further comprising:
an optical member, which comprises an emergent surface from which the exposure light is emitted, wherein
at least a part of the first surface is disposed below the emergent surface of the optical member.

23. An exposure apparatus according to claim 22, further comprising:
an opening, which is disposed below the optical member and via which the exposure light passes, wherein
the first surface is provided around the opening.

24. An exposure apparatus according to claim 23, further comprising:
a supply port, which supplies a liquid to a space between the emergent surface of the optical member and the opening.

25. An exposure apparatus according to claim 1, comprising:
a liquid immersion member, which comprises the first surface, the second surface, and the liquid recovery surface;
wherein,
the liquid immersion member is disposed so that the liquid immersion member surrounds the optical path.

26. An exposure apparatus according to claim 1, wherein
the object comprises the substrate.

27. A device fabricating method, comprising:
exposing a substrate using an exposure apparatus according to any one of claim 1; and
developing the exposed substrate.

28. A liquid immersion system that is used by an immersion exposure, which exposes substrate with exposure light through an optical member and a liquid, in order to fill an optical path between the optical member and the substrate with the liquid, comprising:
a first surface;
a second surface, which is disposed adjacent to an outer edge of the first surface, that includes a first area, which is inclined with respect to the first surface; and
a liquid recovery surface, which is disposed at an outer side of the second surface with respect to the first surface;
wherein,
when an object is disposed at a position at which the object opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object.

29. A liquid immersion system according to claim 28, wherein
the first surface is substantially parallel to the front surface of the object.

30. A liquid immersion system according to claim 28, wherein
the first area is disposed adjacent to the outer edge of the first surface.

31. A liquid immersion system according to claim 30, wherein
the second surface comprises a second area, which is disposed adjacent to an outer edge of the first area, that is substantially parallel to the first surface.

32. A liquid immersion system according to claim 28, wherein
the liquid recovery surface comprises a third area, which is disposed adjacent to an outer edge of the second surface.

33. A liquid immersion system according to claim 32, wherein
the third area is inclined with respect to the first surface.

34. A liquid immersion system according to claim 33, wherein
the third area gradually approaches the front surface of the object along a direction leading away from the optical path.

35. A liquid immersion system according to claim 32, wherein
the third area is substantially parallel to the first surface.

36. A liquid immersion system according to claim 32, wherein
the liquid recovery surface comprises a fourth area, which is disposed at an outer side of the third area; and
the spacing between the fourth area and the object is smaller than the spacing between the third area and the object in the prescribed direction.

37. A liquid immersion system according to claim 36, wherein
at least a part of the fourth area is inclined with respect to the third area.

38. A liquid immersion system according to claim 37, wherein
at least a part of the fourth area gradually approaches the front surface of the object along a direction leading away from the optical path.

39. A liquid immersion system according to claim 36, wherein
at least a part of the fourth area is substantially parallel to the first surface.

40. A liquid immersion system according to claim 39, wherein
the spacing between at least a part of the fourth area and the object is substantially equal to the spacing between the first surface and the object in the prescribed direction.

41. A liquid immersion system according to claim 39, wherein
at least a part of the third area is substantially parallel to the first surface.

42. A liquid immersion system according to claim 36, wherein
the fourth area is disposed adjacent to the outer edge of the third area.

43. A liquid immersion system according to claim 36, wherein
the fourth area is greater than the third area in a radial direction with respect to the optical path of the exposure light.

44. A liquid immersion system according to claim 36, wherein
a suction force at the fourth area is different than a suction force at the third area.

45. A liquid immersion system according to claim 28, wherein
the first surface is lyophilic with respect to the liquid.

46. A liquid immersion system according to claim 28, wherein
the second surface is lyophilic with respect to the liquid.

47. A liquid immersion system according to claim 28, wherein
the liquid recovery surface comprises a front surface of a porous member; and at least part of the liquid on the object, which opposes the liquid recovery surface, is recovered via the porous member.

48. A liquid immersion system according to claim 36, wherein
the liquid recovery surface comprises a front surface of a porous member,
at least a part of the liquid on the object, which opposes the liquid recovery surface, is recovered via the porous member,
a total area of pores of the porous member per unit area at the third area is different than a total area of pores of the porous member per unit area at the fourth area.

49. A liquid immersion system according to claim 28, further comprising:
an opening via which the exposure light can pass,
a supply port from which a liquid is supplied to a space above the opening, wherein
the liquid supplied from the supply port flows into a space, which is between the first surface and the object and is disposed below the opening, via the opening.

50. A liquid immersion system according to claim 28, wherein
the object comprises the substrate.

51. An exposing method, comprising:
using a liquid immersion system according to claim 28 to fill a space between a substrate and an optical member of the immersion exposure apparatus with a liquid; and
radiating an exposure light to the substrate through the optical member and the liquid.

52. A device fabricating method, comprising:
exposing a substrate using an exposing method according to claim 51; and
developing the exposed substrate.

53. An exposure apparatus, comprising:
an optical member from which exposure light is emitted, and
a liquid immersion system according to claim 28, wherein
a space between the optical member and a substrate is filled with a liquid by using the liquid immersion system, and the substrate is exposed with the exposure light via the optical member and the liquid.

54. A device fabricating method, comprising:
exposing a substrate using an exposure apparatus according to claim 53; and
developing the exposed substrate.

55. An exposure apparatus that exposes a substrate with exposure light through a liquid, comprising:
a first surface, which is disposed around an optical path of the exposure light;
a second surface, which is disposed adjacent to an outer edge of the first surface; and
a liquid recovery surface, which is disposed at an outer side of the second surface with respect to the optical path of the exposure light;
wherein,
when an object is stationary at a position at which the object opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object; in addition, an interface of the liquid on the object is formed in the vicinity of a boundary between the second surface and the liquid recovery surface.

56. An exposure apparatus according to claim 55, wherein
the first surface is substantially parallel to the front surface of the object.

57. An exposure apparatus according to claim 55, wherein
the second surface comprises a first area, which is disposed adjacent to the outer edge of the first surface.

58. An exposure apparatus according to claim 57, wherein
the second surface comprises a second area, which is disposed adjacent to an outer edge of the first area, that is substantially parallel to the first surface.

59. An exposure apparatus according to claim 55, wherein
the liquid recovery surface comprises a third area, which is disposed adjacent to an outer edge of the second surface.

60. An exposure apparatus according to claim 55, wherein
the liquid recovery surface comprises a front surface of a porous member; and at least part of the liquid on the object, which opposes the liquid recovery surface, is recovered via the porous member.

61. An exposure apparatus according to claim 55, wherein
the object comprises the substrate.

62. A device fabricating method, comprising:
exposing a substrate using an exposure apparatus according to claim 55; and
developing the exposed substrate.

63. An exposure apparatus that exposes a substrate with exposure light through a liquid, comprising:
a first surface, which is disposed around an optical path of the exposure light;
a second surface, which is disposed adjacent to an outer edge of the first surface; and
a liquid recovery surface, which is disposed at an outer side of the second surface with respect to the optical path of the exposure light;
wherein,
the liquid recovery surface comprises a third area, which is disposed at the outer side of the second surface with respect to the optical path of the exposure light, and a fourth area, which is disposed at the outer side of the third area with respect to the optical path of the exposure light;
when an object is disposed at a position at which the object opposes at least part of the first surface and at least part of the liquid recovery surface, a spacing between the second surface and the object is larger than a spacing between the first surface and the object, a spacing between the third area and the object is larger than the spacing between the first f surface and the object, and the spacing between the fourth area and the object is smaller than the spacing between the third area and the object in a prescribed direction that is substantially perpendicular to a front surface of the object; and
a size of the fourth area is larger than a size of the third area in a radial direction with respect to the optical path of the exposure light.

64. An exposure apparatus according to claim 63, wherein
the liquid recovery surface comprises a front surface of a porous member.

65. An exposure apparatus according to claim 63, wherein
the liquid recovery surface recovers the liquid by suctioning the liquid; and
a suction force at the fourth area is different than a suction force at the third area.

66. An exposure apparatus that exposes a substrate with exposure light through a
liquid, comprising:
a first surface, which is disposed around an optical path of the exposure light;
a second surface, which is disposed adjacent to an outer edge of the first surface; and
a liquid recovery surface, which is disposed at an outer side of the second surface with respect to the optical path of the exposure light, that recovers the liquid by suctioning the liquid;
wherein,
the liquid recovery surface comprises a third area, which is disposed at the outer side of the second surface with respect to the optical path of the exposure light, and a fourth area, which is disposed at the outer side of the third area with respect to the optical path of the exposure light;
when an object is disposed at a position at which the object opposes at least part of the first surface and at least part of the liquid recovery surface, a spacing between the second surface and the object is larger than a spacing between the first surface and the object, a spacing between the third area and the object is larger than the spacing between the first surface and the object, and the spacing between the fourth area and the object is smaller than the spacing between the third area and the object in a prescribed direction that is substantially perpendicular to a front surface of the object; and
a suction force at the fourth area is different than a suction force at the third area.

67. An exposure apparatus according to claim 65, wherein
the liquid recovery surface comprises a front surface of a porous member.

68. An exposure apparatus according to claim 67, wherein
the liquid recovery surface comprises a front surface of a porous member, and at least part of the liquid on the object, which opposes the liquid recovery surface, is suctioned via pores of the porous member; and
a total area of pores of the porous member per unit area at the fourth area is different than a total area of pores of the porous member per unit area at the third area.

69. An exposure apparatus according to claim 67, wherein
the porous member comprises a first porous surface, which opposes the object, and a second porous surface; herein, the pores are formed between the second porous surface and the first porous surface; and
a pressure differential between the first porous surface and the second porous surface at the fourth area is different than a pressure differential between the first porous surface and the second porous surface at the third area.

70. An exposure apparatus according to claim 65, wherein
the suction force at the fourth area is less than the suction force at the third area.

71. An exposure apparatus according to claim 65, wherein
the suction force at the fourth area is greater than the suction force at the third area.

72. An exposure apparatus according to claim 63, wherein
the fourth area is substantially parallel to the first surface.

73. An exposure apparatus according to claim 63, wherein
the first surface is substantially parallel to the front surface of the object.

74. An exposure apparatus according to claim 63, wherein
the spacing between the fourth area and the object is substantially equal to the spacing between the first surface and the object in the prescribed direction.

75. An exposure apparatus according to claim 63, wherein
the third area and the fourth area are substantially parallel.

76. An exposure apparatus according to claim 63, wherein
the second surface comprises a first area, which is disposed adjacent to the outer edge of the first surface, that is inclined with respect to the first surface.

77. An exposure apparatus according to claim 76, wherein
the second surface comprises a second area, which is disposed adjacent to the outer edge of the first area, that is substantially parallel to the first surface.

78. An exposure apparatus according to claim 63, wherein
the third area is disposed adjacent to the outer edge of the second surface with respect to the optical path of the exposure light.

79. An exposure apparatus according to claim 63, wherein
the object comprises the substrate.

80. A device fabricating method, comprising:
exposing a substrate using an exposure apparatus according to claim 63; and
developing the exposed substrate.

81. A liquid immersion system that is used by an immersion exposure, which exposes a substrate with exposure light through an optical member and a liquid, in order to fill an optical path between the optical member and the substrate with the liquid, comprising:
a first surface;
a second surface, which is disposed adjacent to an outer edge of the first surface; and
a liquid recovery surface, which is disposed at an outer side of the second surface with respect to the first surface;
wherein,
when an object is stationary at a position at which the object opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object; in addition, an interface of the liquid on the object is formed in the vicinity of a boundary between the liquid recovery surface and the second surface.

82. A liquid immersion system that is used by an immersion exposure, which exposes a substrate with exposure light through an optical member and a liquid, in order to fill an optical path between the optical member and the substrate with the liquid, comprising:
a first surface;
a second surface, which is disposed around the first surface and adjacent to an outer edge of the first surface; and
a liquid recovery surface, which is disposed around the second surface and adjacent to an outer edge of the second surface;
wherein,
when an object is disposed at a position at which object opposes at least part of the first surface and at least part of the liquid recovery surface, a spacing between the second surface and the object is larger than a spacing between the first surface and the object, and a spacing between the object and at least part of the liquid recovery surface is larger than the spacing between the first surface and the object in a prescribed direction that is substantially perpendicular to a front surface of the object.

83. A liquid immersion system according to claim 81, wherein
the first surface is substantially parallel to the front surface of the object.

84. A liquid immersion system according to claim 81, wherein
the second surface comprises a first area, which is disposed adjacent to an outer edge of the first surface, that is inclined with respect to the first surface.

85. A liquid immersion system according to claim 84, wherein
the second surface comprises a second area that is substantially parallel to the first surface.

86. A liquid immersion system according to claim 85, wherein
the liquid recovery surface is disposed adjacent to an outer edge of the second area.

87. A liquid immersion system according to claim 81, wherein
the liquid recovery surface comprises a front surface of a porous member; and at least a part of the liquid on the object, which opposes the liquid recovery surface, is recovered via the porous member.

88. A liquid immersion system that is used by an immersion exposure apparatus, which exposes a substrate with exposure light through an optical member and a liquid, in order to fill an optical path between the optical member and the substrate with the liquid, comprising:
a first surface;
a second surface, which is disposed adjacent to an outer edge of the first surface; and
a liquid recovery surface, which is disposed at an outer side of the second surface with respect to the first surface;
wherein,
the liquid recovery surface comprises a third area, which is disposed adjacent to an outer edge of the second surface, and a fourth area, which is disposed at the outer side of the third area with respect to the optical path of the exposure light;
when an object is disposed at a position at which the object opposes at least part of the first surface and at least part of the liquid recovery surface, a spacing between the second surface and the object is larger than a spacing between the first surface and the object, a spacing between the third area and the object is larger than the spacing between the first surface and the object, and the spacing between the fourth area and the object is smaller than the spacing between the third area and the object in a prescribed direction that is substantially perpendicular to a front surface of the object; and
a size of the fourth area is larger than a size of the third area in a radial direction with respect to the optical path of the exposure light.

89. A liquid immersion system that is used by an immersion exposure, which exposes a substrate with exposure light through an optical member and a liquid, in order to fill an optical path between the optical member and the substrate with the liquid, comprising:
a first surface;
a second surface, which is disposed adjacent to an outer edge of the first surface; and
a liquid recovery surface, which is disposed at an outer side of the second surface with respect to the first surface;
wherein,
the liquid recovery surface comprises a third area, which is disposed at the outer side of the second surface with respect to the optical path of the exposure light, and a fourth area, which is disposed at the outer side of the third area with respect to the optical path of the exposure light;
when an object is disposed at a position at which the object opposes at least part of the first surface and at least part of the liquid recovery surface, a spacing between the second surface and the object is larger than a spacing between the first surface and the object, a spacing between the third area and the object is larger than the spacing between the first surface and the object, and the spacing between the fourth area and the object is smaller than the spacing between the third area and the object in a prescribed direction that is substantially perpendicular to a front surface of the object; and
a suction force at the fourth area is different than a suction force at the third area.

90. A liquid immersion system according to claims 88, wherein
the first surface is substantially parallel to the front surface of the object.

91. A liquid immersion system according to claim 88, wherein
the second surface comprises a first area, which is disposed adjacent to an outer edge of the first surface, that is inclined with respect to the first surface.

92. A liquid immersion system according to claim 91, wherein
the second surface comprises a second area that is substantially parallel to the first surface.

93. A liquid immersion system according to claim 92, wherein
the liquid recovery surface is disposed adjacent to an outer edge of the second area.

94. A liquid immersion system according to claim 88, wherein
the liquid recovery surface comprises a front surface of a porous member; and
at least part of the liquid on the object, which opposes the liquid recovery surface, is recovered via the porous member.

95. A liquid immersion system according to claim 88, wherein
a spacing between the fourth area and the object is smaller than a spacing between the third area and the object in the prescribed direction.

96. A liquid immersion system according to claim 88, wherein
the fourth area is substantially parallel to the first surface.

97. A liquid immersion system according to claim 96, wherein
the third area is substantially parallel to the first surface.

98. A liquid immersion system according to claim 88, wherein
the fourth area is disposed adjacent to the outer edge of the third area.

99. A liquid immersion system according to claim 88, wherein
the third area is disposed adjacent to the outer edge of the second surface.

100. A liquid immersion system according to claim 88, further comprising:
an opening via which the exposure light can pass; and
a supply port from which a liquid is supplied to a space above the opening, wherein
the liquid supplied from the supply port flows into a space, which is between the first surface and the object and is disposed below the opening, via the opening.

101. A liquid immersion system according to claim 80, wherein
the object comprises the substrate.

102. A liquid immersion system used in a liquid immersion exposure, comprising:
an opening through which exposure light passes, the exposure light being emitted from an emergent surface of an optical element, the opening being disposed below the emergent surface of the optical element;
a first surface disposed around the opening, the first surface facing a predetermined reference surface, the reference surface intersecting with an optical path of the exposure light, which has been passed through the opening;
a supply port from which a liquid is supplied to a space between the emergent surface of the optical element and the opening;
a recess with respect to the first surface, the recess being disposed far from the opening than the first surface, the recess having a depth along a direction leading away from the reference surface;
a wall by which the recess is formed;
a first liquid recovery portion at which the liquid can be recovered, the first liquid recovery portion being provided at least a part of the wall; and
a second liquid recovery portion at which the liquid can be recovered, the second liquid recovery portion being far from the opening than the recess.

103. A liquid immersion system according to claim 102, wherein
the wall comprises a first gradient region, which becomes gradually spaced apart from the reference surface along a direction leading away from the optical path.

104. A liquid immersion system according to claim 102, wherein
the wall comprises a second gradient region, which gradually approaches the reference surface along a direction leading away from the optical path.

105. A liquid immersion system according to claim 104, wherein
at least a part of the first liquid recovery portion is provided in at least a part of the second gradient region.

106. A liquid immersion system according to claim 102, wherein
the wall comprises a substantially flat region, which is substantially parallel to the reference surface, and at least a part of the first liquid recovery portion is provided in at least a part of the flat region.

107. A liquid immersion system according to claim 102, wherein
the second liquid recovery portion faces the reference surface and is substantially parallel to the reference surface.

108. A liquid immersion system according to claim 102, wherein
a suction force at the second liquid recovery portion is different from a suction force at the first liquid recovery portion.

109. A liquid immersion system according to claim 102, wherein
a size of the second liquid recovery portion, in a direction leading away from the optical path, is different from a size of the first liquid recovery portion.

110. A liquid immersion system according to claim 102, wherein
the wall is substantially continuous or substantially intermittent in a direction leading away from the optical path.

111. A liquid immersion system according to claim 102, wherein
the reference surface is set as a location surface for an object surface at an opposing position to the optical member.

112. An exposing method, comprising:
using a liquid immersion system according to claim 80 to fill a space between a substrate and an optical member with a liquid; and
radiating an exposure light to the substrate through the optical member and the liquid.

113. A device fabricating method, comprising:
exposing a substrate using an exposing method according to claim 112; and
developing the exposed substrate.

114. An exposure apparatus comprising:
an optical element having an emergent surface from which exposure light is emitted; and
a liquid immersion system according to any one of claim 80, wherein,
a space between the emergent surface of the optical member and a substrate with a liquid by using the liquid immersion system, and the substrate is exposed with the exposure light via the optical member and the liquid.

115. A device fabricating method comprising:
exposing a substrate using an exposure apparatus according to claim 114; and
developing the exposed substrate.
